(19) United States
(12) Patent Application Publication
(10) Pub. No.: US 2017/0220571 A1
(43) Pub. Date: Aug. 3, 2017

(54) Information Processing Device, Information Processing Method, and Non-Transitory Computer Readable Medium Storing Information Processing Program

(71) Applicant: FUJI XEROX CO., LTD., Tokyo (JP)

(72) Inventor: Shuhei EGAMI, Yokohama-shi (JP)

(73) Assignee: FUJI XEROX CO., LTD., Tokyo (JP)

(21) Appl. No.: 15/221,915

(22) Filed: Jul. 28, 2016

(30) Foreign Application Priority Data
Jan. 29, 2016 (JP) 2016-015611

(51) Int. Cl. G06F 17/30

(52) U.S. Cl. CPC G06F 17/3033; G06F 17/30424

(57) ABSTRACT

An information processing device includes: a first storage section that stores a token, a name of a substance, and information indicative of the substance; a second storage section that stores the token, the information indicative of the substance, and a hash value; a third storage section that stores the hash value and data. In a case in which a token indicative of a user, a name, and an instruction to process data relevant to a substance indicated by the name is received, information indicative of the substance corresponding to the token and the name is extracted from the first storage section; the hash value corresponding to the received token and the extracted information indicative of the substance are extracted from the second storage section; and the data corresponding to the extracted hash value is extracted from the third storage section.

### CROSS-REFERENCE TO RELATED APPLICATIONS

This application is based on and claims priority under 35 USC 119 from Japanese Patent Application No. 2016-015611 filed on Jan. 29, 2016.

### BACKGROUND

### Technical Field

The present invention relates to an information processing device, an information processing method, and a non-transitory computer readable medium storing an information processing program.

### SUMMARY

According to an aspect of the present invention, there is provided an information processing device including: a first storage section that stores a token, a name of a substance, and information indicative of the substance in association with one another; a second storage section that stores the token, the information indicative of the substance, and a hash value in association with one another; a third storage section that stores the hash value and data in association with one another; a first extraction section that, in a case in which a token indicative of a user, a name, and an instruction to process data relevant to a substance indicated by the name are received, extracts the information indicative of the substance corresponding to the received token and the received name from the first storage section; a second extraction section that extracts, from the second storage section, the hash value corresponding to the received token and the information indicative of the substance extracted by the first extraction section; a third extraction section that extracts, from the third storage section, the data corresponding to the hash value extracted by the second extraction section; and a processing section that performs, according to the instruction, a process on the data extracted by the third extraction section.

### BRIEF DESCRIPTION OF THE DRAWINGS

Exemplary embodiments of the present invention will be described in detail based on the following figures, wherein:

FIG. 1 is a diagram illustrating a conceptual module configuration for an example of a configuration according to a first embodiment;

FIG. 2 is an explanatory diagram illustrating an example of a system configuration using the exemplary embodiment;

FIG. 3 is an explanatory diagram illustrating an example of the functions of a resource management device;

FIG. 4 is an explanatory diagram illustrating an example of a process of an existing KeyValueStore;

FIG. 5 is an explanatory diagram illustrating an example of a process of the existing KeyValueStore;

FIG. 6 is an explanatory diagram illustrating an example of a process of the existing KeyValueStore;

FIG. 7 is an explanatory diagram illustrating an example of a process of the existing KeyValueStore;

FIG. 8 is an explanatory diagram illustrating an example of a process of the existing KeyValueStore;

FIG. 9 is an explanatory diagram illustrating an example of the data structure of a name management table;

FIG. 10 is an explanatory diagram illustrating an example of the data structure of a data attribute management table;

FIG. 11 is an explanatory diagram illustrating an example of the data structure of a data management table;

FIG. 12 is an explanatory diagram illustrating an example of a process according to the first embodiment;

FIG. 13 is a flowchart illustrating an example of a process according to the first embodiment;

FIG. 14 is an explanatory diagram illustrating an example of a process according to the first embodiment;

FIG. 15 is a flowchart illustrating an example of a process according to the first embodiment;

FIG. 16 is an explanatory diagram illustrating an example of a process according to the first embodiment;

FIG. 17 is a flowchart illustrating an example of a process according to the first embodiment;

FIG. 18 is an explanatory diagram illustrating an example of a process according to the first embodiment;

FIG. 19 is a diagram illustrating conceptual module configuration for an example of configuration according to a second embodiment;

FIG. 20 is an explanatory diagram illustrating an example of the data structure of a token management table;

FIG. 21 is an explanatory diagram illustrating an example of the data structure of a ticket management table;

FIGS. 22A and 22B are explanatory diagrams illustrating examples of the data structures of a name management table and a data attribute management table;

FIG. 23 is an explanatory diagram illustrating an example of a process according to a second embodiment;

FIG. 24 is a flowchart illustrating an example of a process according to the second embodiment;

FIG. 25 is an explanatory diagram illustrating an example of a process according to the second embodiment;

FIG. 26 is an explanatory diagram illustrating an example of a process according to the second embodiment;

FIG. 27 is an explanatory diagram illustrating an example of the data structure of a token management table;

FIG. 28 is an explanatory diagram illustrating an example of the data structure of a user ticket management table;

FIG. 29 is an explanatory diagram illustrating an example of a process according to the second embodiment; and

FIG. 30 is a block diagram illustrating an example of hardware configuration of a computer which realizes the exemplary embodiment.

### DETAILED DESCRIPTION

A KeyValueStore (hereinafter also referred to as KVS) is one of data preservation and management methods, and is a method of setting a relevant unique sign (key) to an arbitrary data (value), which is desired to be preserved, and preserving the sign and the data as a pair. In addition, the KeyValueStore includes a case in which a system or software that provides such a function is indicated.

In the KVS, a character string and a numerical value (referred to as a key) are allocated to data, which is desired to be preserved, in order to discriminate the data from other data, and the character string and the numerical value are stored in the storage device or the like, together with the data, as a set. In a case in which the data is read, it is possible to extract the relevant data if a previously set key is designated. The type of data which can be preserved may include electronic data such as a character string, an image, and a video.

In a system in which it is possible to CRUD arbitrary data by HTTP as the KeyValueStore, data is registered and is associated for data analysis and utilization. Since data of various systems are registered, it is necessary to prevent data registered by another system from being overwritten due to the data of the various systems. Therefore, there is provided a system in which a system which manages the whole generates a random character string in a case in which the data is registered, and a client acquires, updates, and deletes the data using the random character string.

Therefore, it is possible to gather the data, which are maintained by the plural systems, at one place.

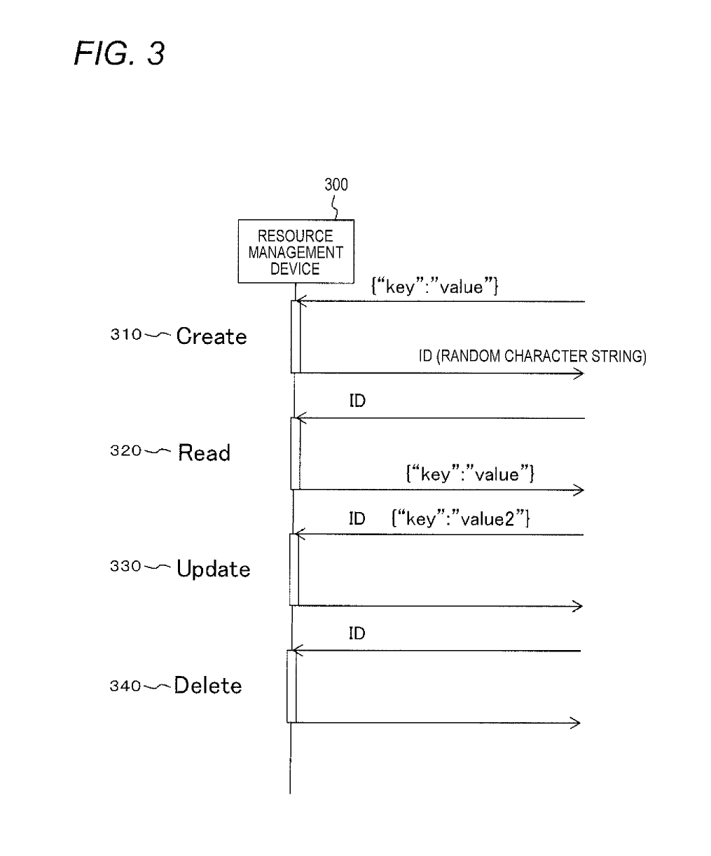

Meanwhile, CRUD indicates four basic functions which are included in almost all pieces of computer software. Specifically, Create, Read, Update, and Delete are included. CRUD is also used as a term which indicates functions (refer to/search/update information) which should be included in a user interface. As illustrated in an example of FIG. 3, in a case in which a resource management device 300 receives an instruction Create 310, the resource management device 300 registers {“key”, “value”}, and returns an ID (random character string) used to extract a {“key”, “value”} pair. Further, in a case in which the resource management device 300 receives an instruction Read 320, the resource management device 300 returns the {“key”, “value”} pair corresponding to the ID in a case in which the ID (ID which is returned by Create 310). In addition, in a case in which the resource management device 300 receives an instruction of Update 330, the resource management device 300 receives the ID and a {“key”, “value2”} pair, and rewrites the {“key”, “value”} corresponding to the ID into {“key”, “value2”}. Further, in a case in which the resource management device 300 receives an instruction of Delete 340, the deletes {“key”, “value”} ({“key”, “value2”} after the Update 330 is executed), which is data corresponding to the ID, is deleted from the inside of the resource management device 300.

In a case in which a random character string is used to allocate data for a specific substance (also referred to as a device) as an ID across plural systems, the following problems are generated.
Preparation of index in order to prevent an ID from being lost.

That is, the relationship between IDs, which are used by respective systems, and the random character strings should be preserved somewhere.
Collection of IDs from plural data sources for name identification That is, IDs, which are stored in the respective systems, should be bound and managed in a case in which data is referred to across the plural systems.
Process of extracting a data ID from the collected data in a case in which data is used

That is, in a case in which it is desired to refer to another data as a result of reference of the data across the plural systems, the relationship is not preserved, and thus a system in which the relationship can be resolved should be inquired.

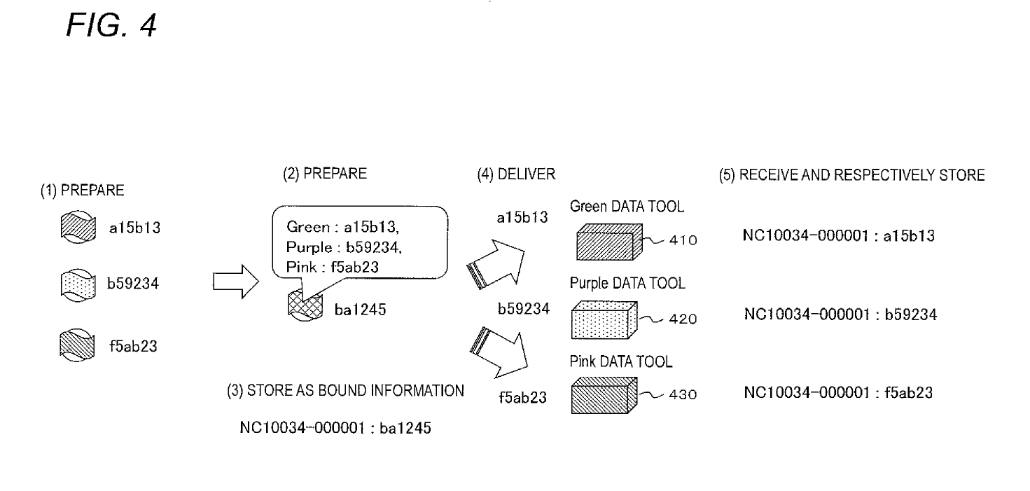

As illustrated in an example of FIG. 4, in “(1) prepare”, IDs which are random character strings are allocated to substances. Further, in “(2) prepare”, the three IDs are collected, and new IDs (random character strings) are allocated. Subsequently, in “(3) prepare as bound information”, it is necessary to associate the IDs, which are prepared in (2), with substance IDs. Further, in “(4) deliver”, the IDs of the respective systems are delivered to respective data tools (respective systems). In “(5) receive and respectively store”, it is necessary to store pairs of the substance IDs and the IDs, which are the random character strings, in the respective data tools.

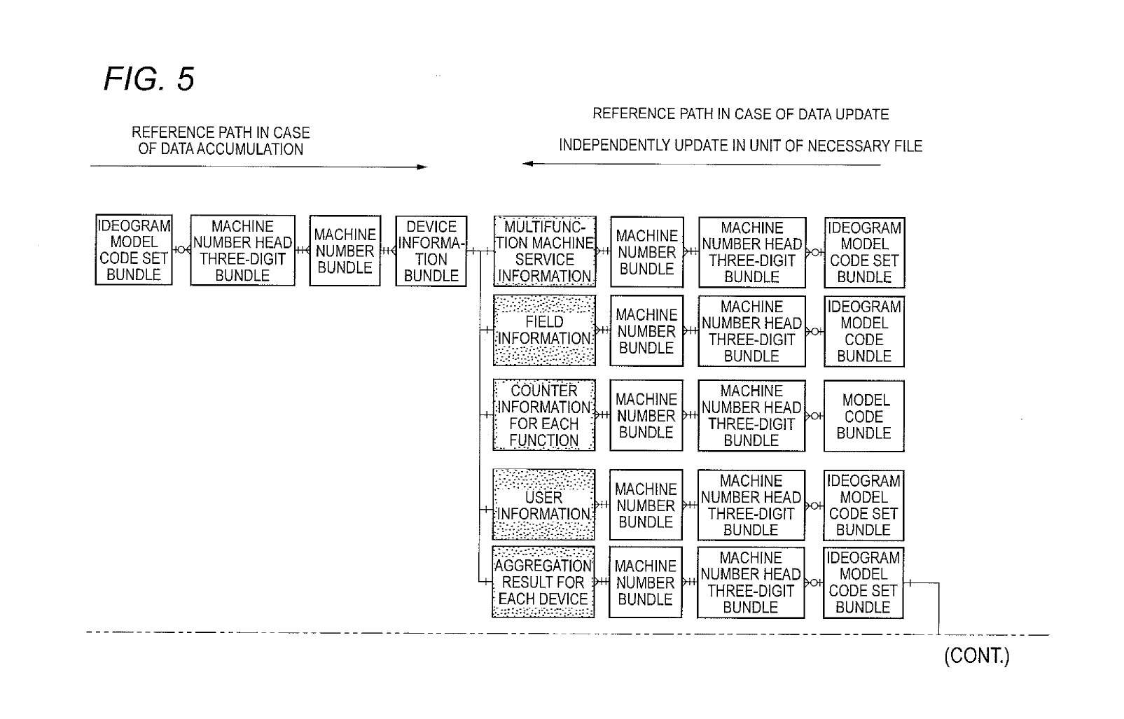

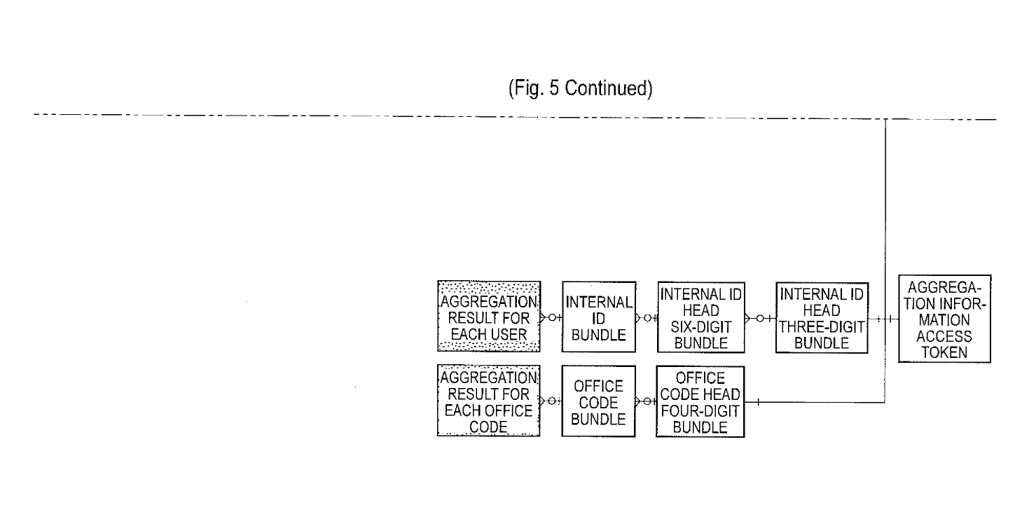

In a case in which data is prepared as described above, it is difficult to perform an operation if a large amount of “data which binds data” is not prepared in addition to essential “data”. For example, as illustrated in FIG. 5, in respective systems, plural indexes are prepared for “multifunction machine service information”, “field information”, “counter information for each function”, “user information”, an “aggregation result for each device”, an “aggregation result for each user”, and an “aggregation result for each office code” which are data. For example, in a case in which the “multifunction machine service information” or the like is referred to as a reference path in a case of data aggregation, it is necessary to refer to the following indexes of an “ideogram model code set bundle”, a “machine number head three-digit bundle”, a “machine number bundle”, and a “device information bundle”. In addition, in a case in which the “multifunction machine service information” is referred to as a reference path in a case of data update, it is necessary to refer to the following indexes of the “ideogram model code set bundle”, the “machine number three-digit bundle”, the “machine number bundle”. Further, even in a case of the same device, an index is differently called according to the system as in an “ideogram model code set”, an “ideogram model code”, and a “model code”, and thus plural paths exist.

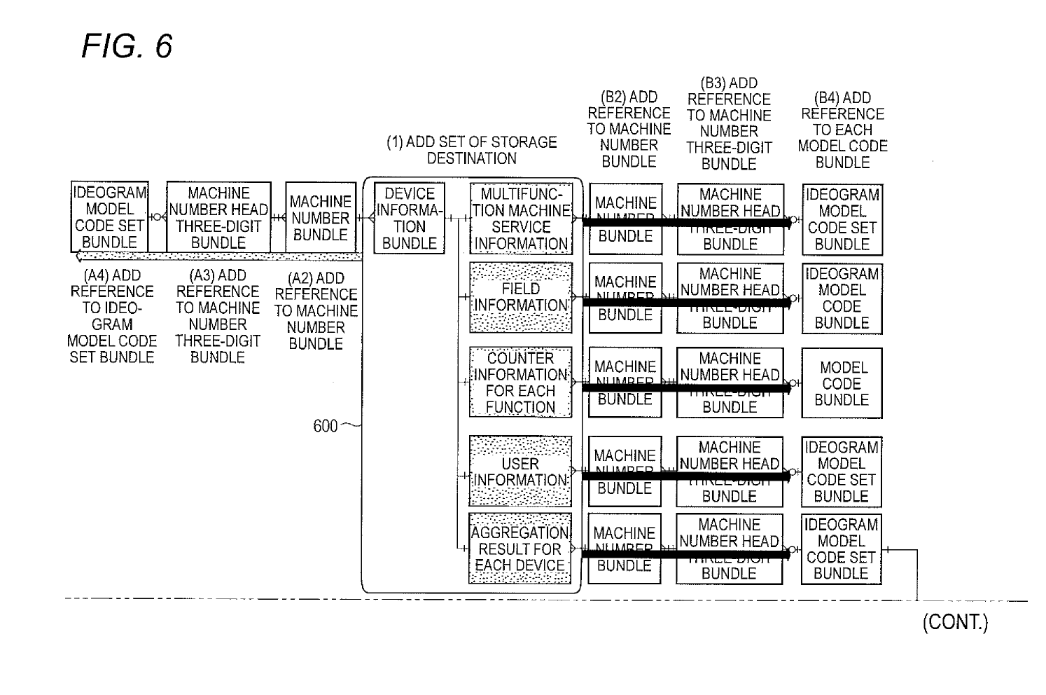

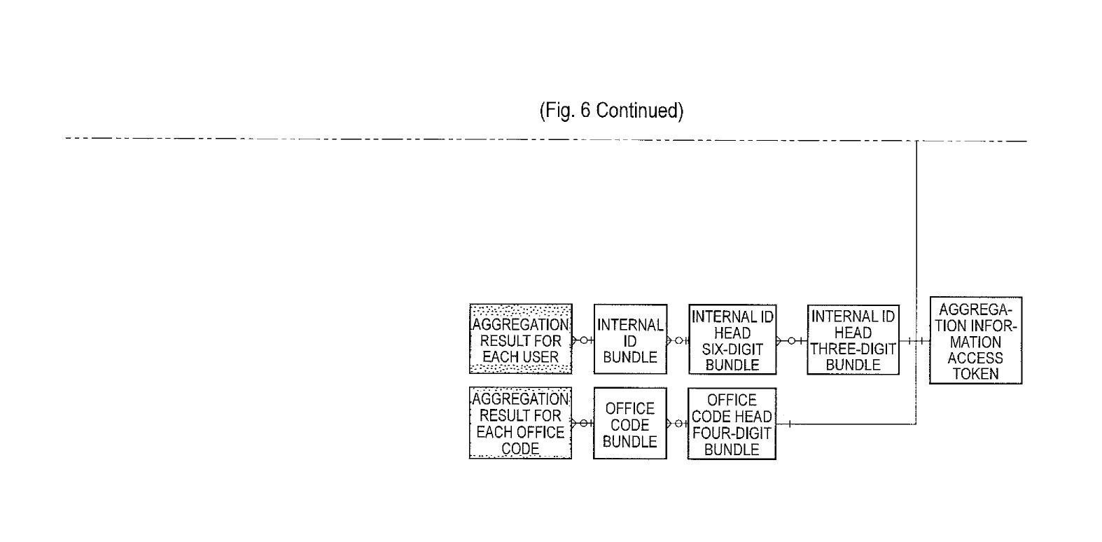

In addition, the enlargement of a process due to the extension of the update process in a case of data addition will be described using an example of FIG. 6.

For example, various pieces of information should be added to the indexes in accordance that a set addition target 600 is added to the structure illustrated in FIG. 5.

That is, (1) in a case in which the set addition target 600 is added, (A2) reference to the machine number bundle is added, (A3) reference to the machine number three-digit bundle is added, (A4) and reference to the ideogram model code set bundle is added. Further, and it is necessary that (B2) reference to the machine number bundle is added, (B3) reference to the machine number three-digit bundle is added, and (B4) reference to each model code bundle is added.

Furthermore, with regard to the indexes, data of a reference source is prepared owing to the presence of the data of a reference destination, and thus it is difficult to collectively prepare data. That is, a lot of processes are necessary for indexes other than the storage of the data of the set addition target 600.

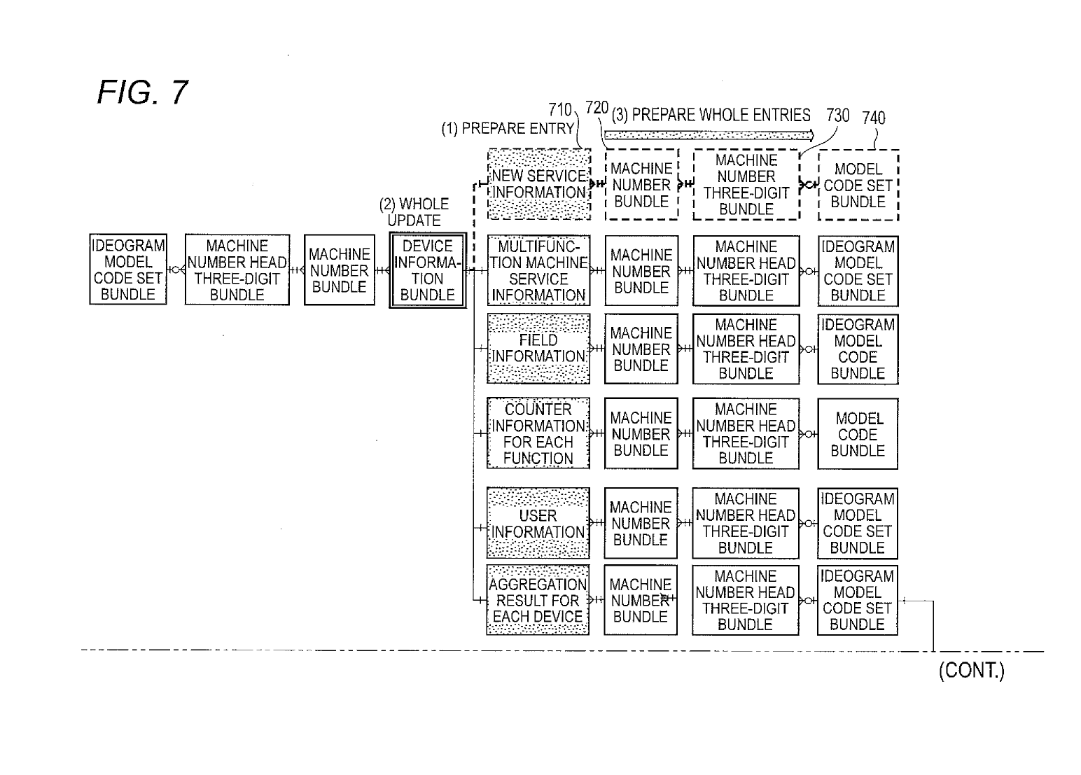

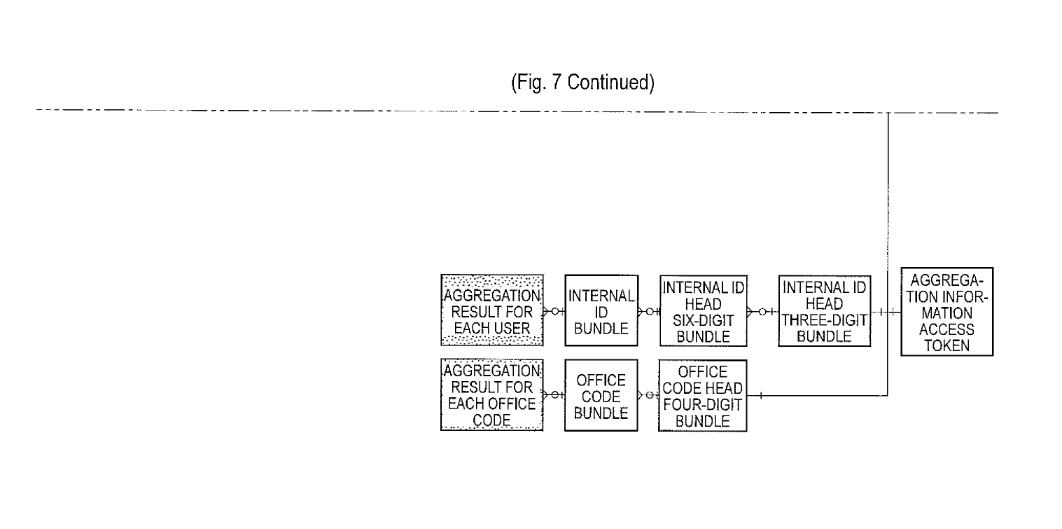

Subsequently, the extension of the update process in the case of data addition will be described using an example of FIG. 7.
(1) In a case in which the entry of new service information 710 is prepared (added), (2) the whole device information bundle is updated, and (3) it is necessary to sequentially prepare a machine number bundle 720, a machine number three-digit bundle 730, and a model code set bundle 740. That is, as described above, only when one type of information is added, a huge number of updates occur.

However, whether or not to actually use the service depends on the user, useless entry preparation and update processes are generated.

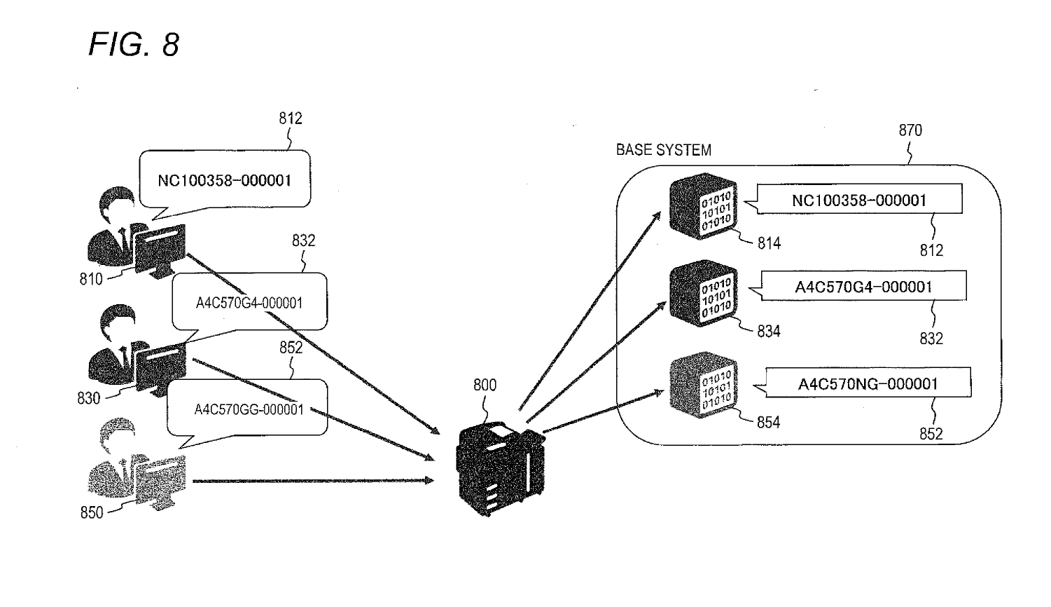

In an existing KeyValueStore system, one-to-one correspondence exists between the name of data and the data, and thus IDs, in which there is no connection at all, are necessary for assignment without duplications. For example, as illustrated in FIG. 8, in a case in which a substance 800 is designated, “NC100358-000001” is used as a name 812 in a system 810, “A4C570G4-000001” is used as a name 832 in a system 830, and “A4C570NG-000001” is used as a name 852 in a system 850.

This causes the above-described complexity of ID management to occur, and thus it is difficult to use the system. In the example of FIG. 8, with regard to one substance 800, the name 812 of data 814, the name 832 of data 834, and the name 852 of data 854 should be used in a base system 870.

The reason for this is that it is difficult to conceive that there are plural names and plural data on the basis of the substance, and it is possible to resolve the problem using information indicative of the substance (ID).

Hereinafter, various examples of embodiments, which are suitable to realize the present invention, will be described with reference to the accompanying drawings.

### First Embodiment

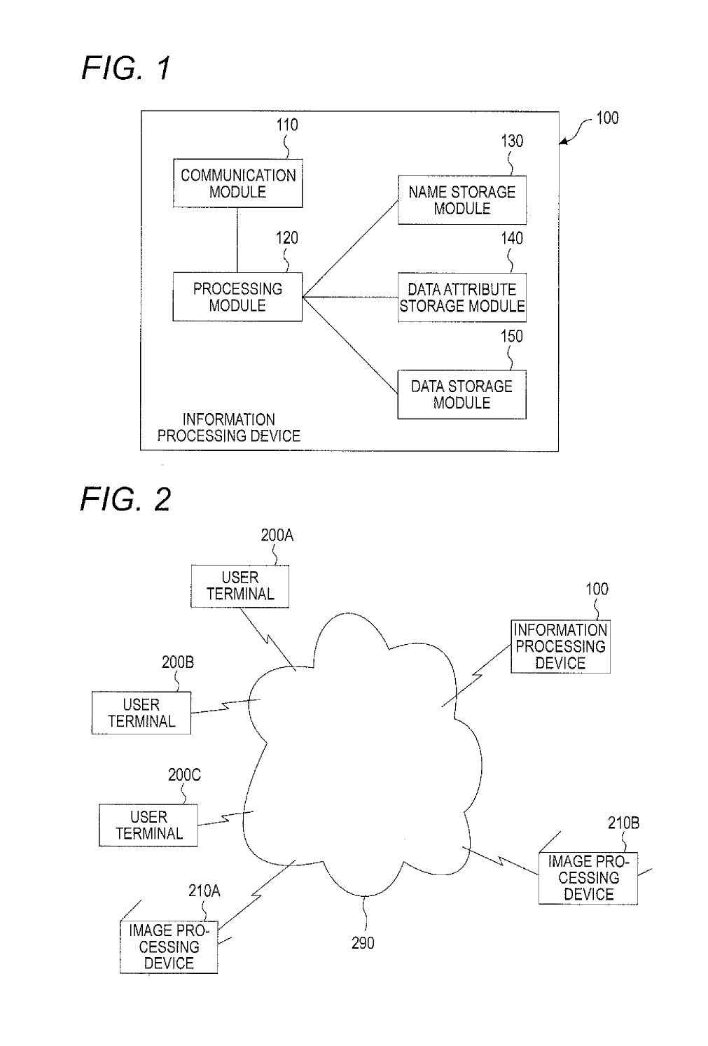

FIG. 1 is a diagram illustrating a conceptual module configuration for an example of a configuration according to a first embodiment.

Meanwhile, modules typically indicate components, such as software (computer program) and hardware, which can be logically separated. Accordingly, modules in the exemplary embodiment indicate modules in a hardware configuration in addition to modules in a computer program. Therefore, in the exemplary embodiment, computer programs (a program which causes a computer to execute respective procedures, a program which causes the computer to function as respective sections, and a program which causes the computer to realize respective functions) which are caused to function as the modules, systems, and methods are described. Meanwhile, for convenience of explanation, words “store”, “cause to be stored”, and equivalent words thereof are used. In a case in which the exemplary embodiment corresponds to a computer program, the words means to store in a storage device or to perform control to be stored in the storage device. In addition, although modules may correspond to functions one by one, one module may be formed by one program, plural modules may be formed by one program, or, on the contrary, one module may be formed by plural programs for implementations. In addition, plural modules may be executed by one computer or one module may be executed by plural computers using computers in a distributed or parallel environment. Meanwhile, one module may include another module. In addition, hereinafter, “connection” is used in a case of logical connection (transmission and reception of data, instruction, reference relationship between data, or the like) in addition to physical connection. “Predetermined” indicates “determined before a process which is a target is performed”, and is used while including a meaning of “determined according to a situation and a state at that time or according to a situation and a state until that time if a target process is not performed even in a case after a process according to the exemplary embodiment starts as well as a case before the process according to the exemplary embodiment starts. In a case in which there are plural “predetermined values”, the predetermined values may be different values, respectively, or two or more values (apparently including all the values) may be the same. In addition, description, which has a meaning of “in a case of A, perform B”, is used as a meaning of “determine whether or not it is A, and perform B in a case in which it is determined to be A”. However, a case in which it is not necessary to determine whether or not it is A is excluded.

In addition, a system or a device includes a configuration which is realized by one computer, hardware, one device, or the like in addition to a configuration in which plural computers, hardware, devices, or the like are connected through a communication section, such as a network (including communication connection of one-to-one correspondence). The “device” and the “system” are used as synonymous terms. It is apparent that the “system” does not include a mere social “structure” (social system) which is artificial decision.

In addition, in a case of each process performed by each module or a case in which plural processes are performed in a module, target information is read from a storage device for each process, the process is performed, and the result of the process is written in the storage device. Accordingly, there is a case in which reading from the storage device before the process is performed and writing in the storage device after the process is performed may not be described. Meanwhile, here, the storage device may include a hard disk, a Random Access Memory (RAM), an external storage medium, a storage device connected through a communication line, a register in a Central Processing Unit (CPU), and the like.

An information processing device 100 according to the first embodiment has a function as the KeyValueStore, and includes a communication module 110, a processing module 120, a name storage module 130, a data attribute storage module 140, and a data storage module 150, as illustrated in FIG. 1.

The information processing device 100 may be used, for example, as a system which performs authorization by a BEARER token of OAUTH 2.0 in order to identify a user. Further, the information processing device 100 may be used as a system which provides an interface of REST and in which POST/GET/PUT/DELETE of the Hypertext Transfer Protocol (HTTP) correspond to prepare/acquire/update/delete of data.

The information processing device 100 is a system which has a function capable of performing setting such that a substance indicated by a certain user (another user) using a “certain name A” is the same substance indicated by the information processing device 100 using a “certain name B”. The “certain name A” and the “certain name B” may be different from each other for respective systems (a system which is used by the certain user and a system of the information processing device 100). It is apparent that the “certain name A” may be the same as the “certain name B”.

The communication module 110 is connected to the processing module 120. The communication module 110 communicates with another information processing device. For example, an information processing device, which communicates with the information processing device 100, includes a user terminal 200, an image processing device 210, and the like which are illustrated in an example of the FIG. 2.

The communication module 110 receives a “token indicative of a user”, a “name”, and an “instruction to process data relevant to a substance indicated by the name” from another information processing device. Here, for example, the above-described BEARER token of OAUTH 2.0 is used as the “token indicative of a user”. The instruction includes, for example, the above-described CRUD. More specifically, the above-described POST/GET/PUT/DELETE of HTTP correspond to the instruction.

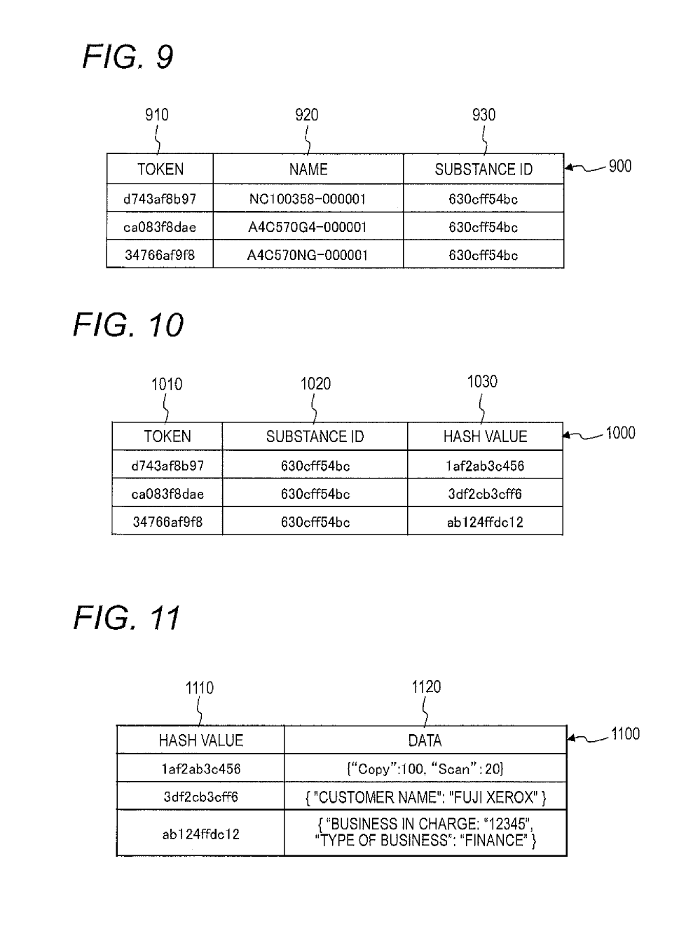

The name storage module 130 is connected to the processing module 120. The name storage module 130 stores a token, a name of a substance, and information indicative of the substance in association with one another. For example, the name storage module 130 stores a name management table 900. FIG. 9 is an explanatory diagram illustrating an example of the data structure of the name management table 900. The name management table 900 includes a token field 910, a name field 920, and a substance ID field 930. That is, an ID which indicates a substance is managed through the combination of an access token and a name. The token field 910 stores a token. The name field 920 stores a name of a substance. The substance ID field 930 stores information (substance ID: IDentification) for uniquely identifying the substance in the exemplary embodiment.

Here, the name is a name in a system which is used by the user, and the name of the same substance may be different for respective systems. That is, for the same substance, it is allowed that, for example, “NC100358-000001” is used in a system A and a different name, that is, “A4C570G4-000001” is used in a system B. It is apparent that the same name may be used for the same substance even in different systems.

The data attribute storage module 140 is connected to the processing module 120. The data attribute storage module 140 stores a token, information indicative of a substance, and a hash value in association with one another. For example, the data attribute storage module 140 stores a data attribute management table 1000. FIG. 10 is an explanatory diagram illustrating an example of the data structure of the data attribute management table 1000. The data attribute management table 1000 includes a token field 1010, a substance ID field 1020, and a hash value field 1030. That is, the hash value of data is managed through the combination of an access token and an ID which indicates the substance. The token field 1010 stores a token. The substance ID field 1020 stores a substance ID. The hash value field 1030 stores a hash value.

The data storage module 150 is connected to the processing module 120. The data storage module 150 stores a hash value and data in association with one another. For example, the data storage module 150 stores a data management table 1100. FIG. 11 is an explanatory diagram illustrating an example of the data structure of the data management table 1100. The data management table 1100 includes a hash value field 1110 and a data field 1120. That is, the data management table 1100 is a KeyValueStore-type database in which data is set to a value based on a hash value as a key. The hash value field 1110 stores a hash value. The data field 1120 stores data. Meanwhile, although the format of the data in the data field 1120 is formed by a pair (group) of an attribute name and an attribute value, the format of the data may include another data format in addition to the above-described format. For example, the format of the data may include a matrix, a file, image, sound, video, and the like.

The processing module 120 is connected to the communication module 110, the name storage module 130, the data attribute storage module 140, and the data storage module 150. In a case in which the communication module 110 receives a “token indicative of a user”, a “name”, and an “instruction to process data relevant to a substance indicated by the name”, the processing module 120 extracts the token and information indicative of the substance from the name storage module 130.

Further, the processing module 120 extracts the “token which is received by the communication module 110” and a “hash value” corresponding to the “information indicative of the extracted substance” from the data attribute storage module 140.

Subsequently, the processing module 120 extracts data corresponding to the “extracted hash value” from the data storage module 150.

Further, a process is performed on the extracted data according to the instruction which is received by the communication module 110.

FIG. 2 is an explanatory diagram illustrating an example of the configuration of the system using the exemplary embodiment.

The information processing device 100, a user terminal 200A, a user terminal 200B, a user terminal 200C, an image processing device 210A, and an image processing device 210B are connected to each other through a communication line 290. The communication line 290 may be a wired line, a wireless line, or the combination thereof, and may include, for example, the Internet, the intranet or the like as communication infrastructure. In addition, a function performed by the information processing device 100 may be realized as a cloud service.

The user terminal 200 is an information processing device which is used by a user, and includes, for example, a personal computer (PC including, for example, a desktop PC, a notebook PC, or the like) and a mobile terminal (a mobile phone or the like such as a smart phone). The image processing device 210 includes a copying machine, a facsimile, a scanner, a printer, a multifunction machine (an image processing device which has two or more functions of the scanner, the printer, the copying machine, the facsimile, and the like), and the like. For example, the history (log) or the like of a process may be transmitted from the image processing device 210. In addition, the image processing device 210 may be a home information appliance, a robot, or the like.

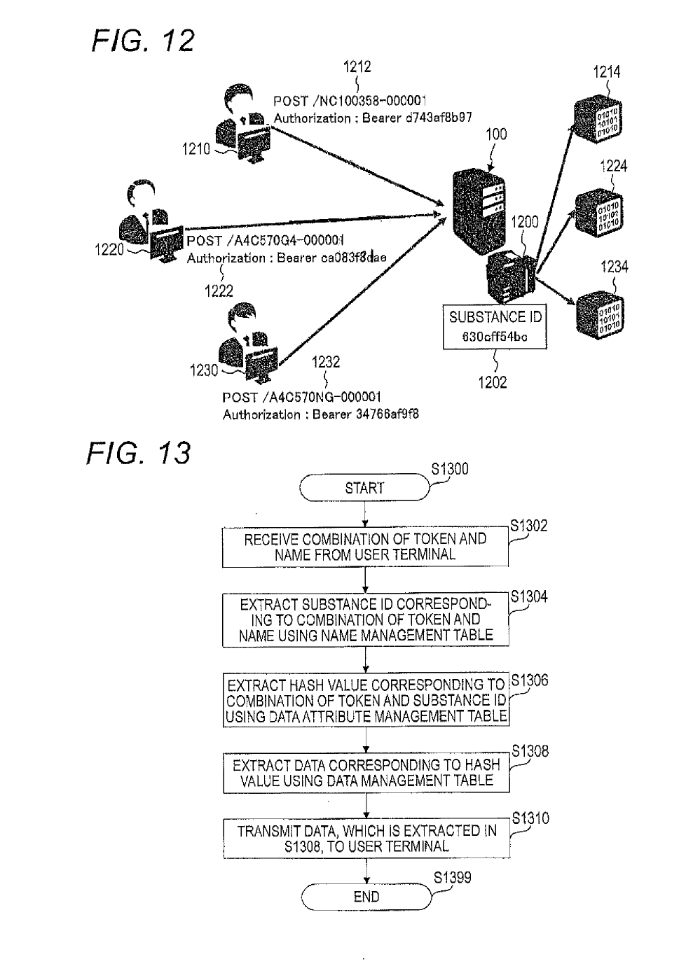

FIG. 12 is an explanatory diagram illustrating an example of a process according to the first embodiment.

The information processing device 100 receives an instruction 1212 from a user terminal 1210, an instruction 1222 from a user terminal 1220, and an instruction 1232 from a user terminal 1230. The instruction 1212 includes, for example, “POST/NC100358-000001 Authorization: Bearer d743af8b97”. The instruction 1222 includes, for example, “POST/A4C570G4-000001 Authorization: Bearer ca083f8dae”. The instruction 1232 includes, for example, “POST/A4C570NG-000001 Authorization: Bearer34766af9f8”.

That is, the information processing device 100 receives the “instructions to process the data relevant to the substance indicated by the name”, the “names”, and the “tokens” which are described above.

Further, the names indicate a substance 1200 (substance ID 1202), and processes according to the instructions are performed on data 1214, data 1224, and data 1234 which are associated with the substance 1200 (substance ID 1202). The detailed content of the process will be described using examples of FIGS. 13 to 18,

FIG. 13 is a flowchart illustrating an example of a process according to the first embodiment.

In step S1302, the combination of a token and a name is received from the user terminal.

In step S1304, a substance ID corresponding to the combination of the token and the name is extracted using the name management table 900.

In step S1306, a hash value corresponding to the combination of the token and the substance ID is extracted using the data attribute management table 1000.

In step S1308, data corresponding to the hash value is extracted using the data management table 1100.

In step S1310, the data, which is extracted in step S1308, is transmitted to the user terminal.

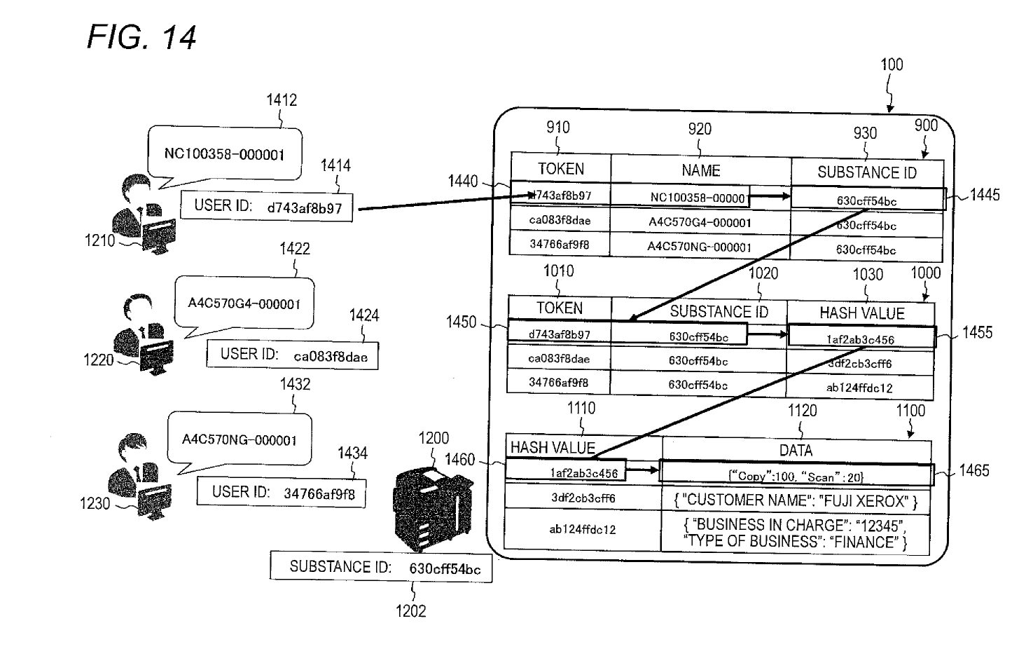

FIG. 14 is an explanatory diagram illustrating an example of a process according to the first embodiment (a detailed example of the process according to the flowchart illustrated in the example of FIG. 13). FIG. 14 illustrates an example of a process of specifying the substance indicated by the user and specifying the data according to the combination of the substance and the user using the name management table 900.

The user terminal 1210 transmits a name 1412 of the substance 1200 of the system and a certain user ID 1414, which is the token, to the information processing device 100. Meanwhile, although the “instruction” is omitted in the example of FIG. 14, the “instruction” may be, for example, “Read” or the like.

The information processing device 100 receives the name 1412 and the user ID 1414, and extracts a line of target data 1440 from the name management table 900. The target data 1440 is the combination of data in the token field 910 and data in the name field 920. Further, the information processing device 100 extracts target data 1445, which corresponds to the target data 1440, in the substance ID field 930. Subsequently, the information processing device 100 extracts a line (target data 1450) of the combination of the certain user ID 1414, which is the token, and the target data 1445 from the data attribute management table 1000. The target data 1450 is the combination of data in the token field 1010 and data in the substance ID field 1020. Further, the information processing device 100 extracts target data 1455, which corresponds to the target data 1450, in the hash value field 1030. Subsequently, the information processing device 100 extracts target data 1460, which corresponds to the target data 1455, in the hash value field 1110 from the data management table 1100. Further, the information processing device 100 extracts target data 1465 which corresponds to the target data 1460. The target data 1465 is data in the data field 1120. Further, a process according to an “instruction”, which is transmitted from the user terminal 1210, is performed on the target data 1465. In an example of the above-described “Read”, the target data 1465 is returned to the user terminal 1210.

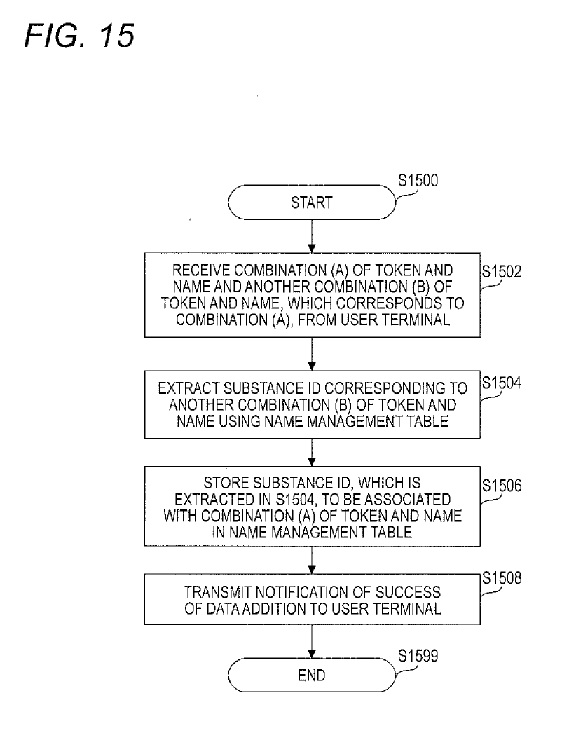

FIG. 15 is a flowchart illustrating an example of a process according to the first embodiment.

In step S1502, the information processing device 100 receives the combination (A) of a token and a name and another combination (B) of the token and the name, which corresponds to the combination (A), from the user terminal.

In step S1504, the information processing device 100 extracts an substance ID corresponding to another combination (B) of the token and the name using the name management table 900.

In step S1506, the information processing device 100 stores the substance ID, which is extracted in step S1504, and the combination (A) of the token and the name in the name management table 900 in association with one another.

In step S1508, the information processing device 100 transmits a notification of the success of data addition to the user terminal.

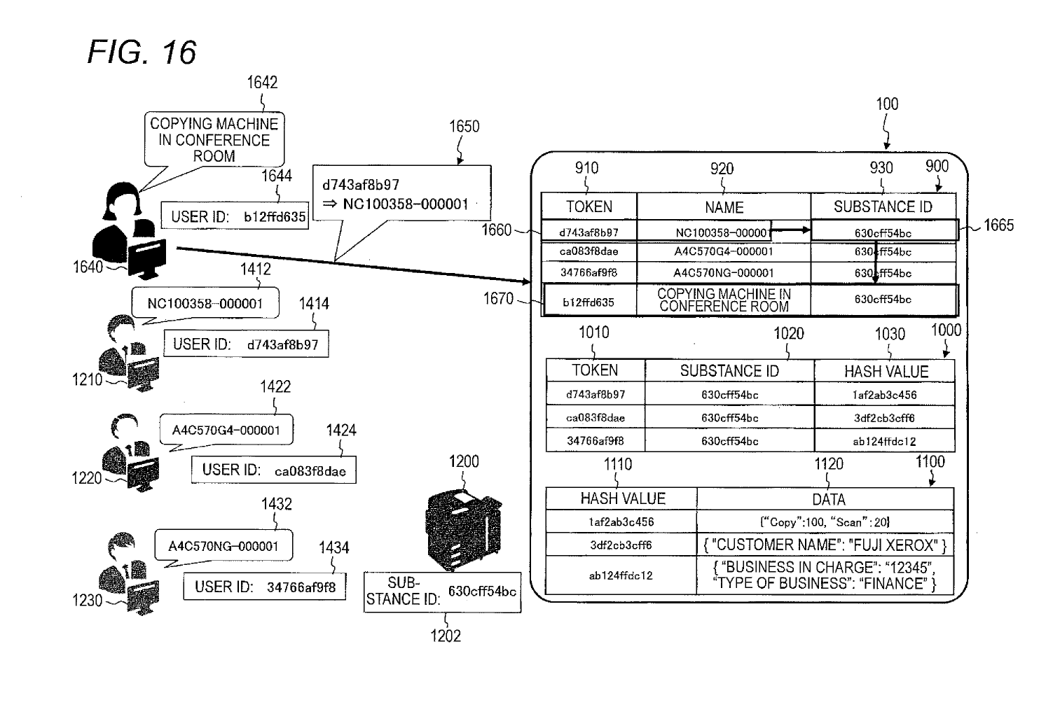

FIG. 16 is an explanatory diagram illustrating an example of a process according to the first embodiment (a detailed example of the process according to the flowchart illustrated in the example of FIG. 15). FIG. 16 illustrates an example of a process in a case of adding a new data set. That is, the correspondence relationship between the name and the substance ID is registered.

Specifically, a process is performed in a case in which a user who uses a user terminal 1640 obtains a name correspondence table, and a fact that “the copying machine in the conference room” (a name 1642, that is, the name of the substance 1200) of the user terminal 1640 is the same as “NC100358-000001” of the user A of the user terminal 1210 is registered through an interface for name registration in the information processing device 100. That is, the process is a process (name sorting process) of naming one substance 1200 as the “copying machine in a conference room” in the system of the user terminal 1640, naming the substance 1200 as “NC100358-000001” in the system of the user terminal 1210, and expressing that those indicate the same substance. Although the “instruction” is omitted in the example of FIG. 16, the “instruction” is “Create”.

The user terminal 1640 transmits a user ID 1644, which is the token, and name correspondence data 1650 to the information processing device 100. The name correspondence data 1650 indicates that the name 1642 (“the copying machine in the conference room”) of the user ID 1644 (user ID: b12ffd635) and the name 1412 (NC100358-000001) of the user ID 1414 (d743af8b97) indicate the same substance.

The information processing device 100 receives the user ID 1644, the name 1642, and the name correspondence data 1650, and extracts a line of target data 1660 from the name management table 900 using the name correspondence data 1650. That is, the information processing device 100 extracts the line of the target data 1660 which is the combination of the token and the name (name which is registered in the name management table 900 in advance) in the name correspondence data 1650. Meanwhile, the target data 1660 is the combination of the data in the token field 910 and the data in the name field 920. Further, the information processing device 100 extracts target data 1665, which corresponds to the target data 1660, in the substance ID field 930.

Subsequently, the information processing device 100 adds a new line (target data 1670) to the name management table 900, inserts the user ID 1644 which is the token into the token field 910, inserts the name 1642 into the name field 920, and inserts the target data 1665 into the substance ID field 930. Meanwhile, the target data 1670 is the combination of data in the token field 910, data in the name field 920, and data in the substance ID field 930.

In a case in which the target data 1670 is added to the name management table 900, it is possible to associate the user corresponding to the user ID 1644 with the substance 1200 using the name “the copying machine in the conference room”.

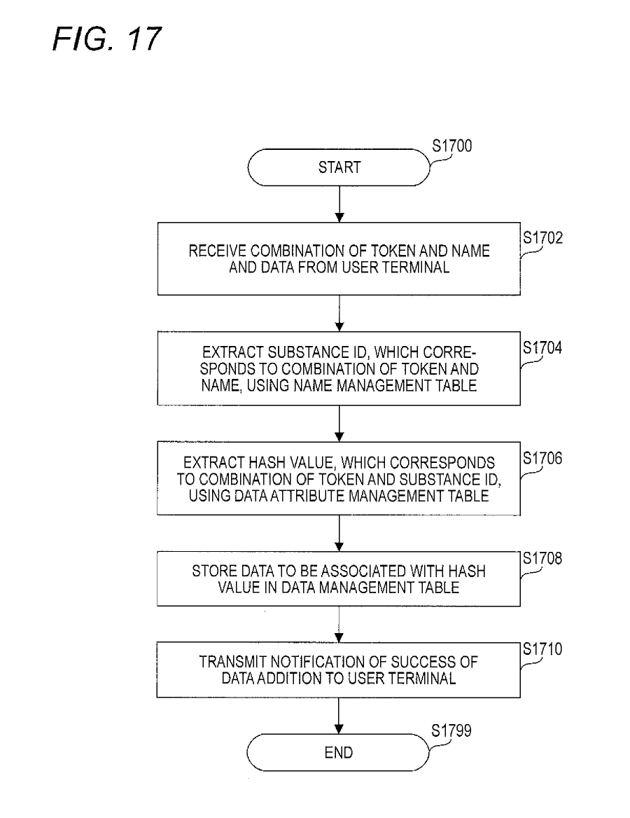

FIG. 17 is a flowchart illustrating an example of a process according to the first embodiment.

In step S1702, the information processing device 100 receives the combination of the token and the name and data from the user terminal.

In step S1704, the information processing device 100 extracts a substance ID, which corresponds to the combination of the token and the name, using the name management table 900.

In step S1706, the information processing device 100 extracts a hash value, which corresponds to the combination of the token and the substance ID, using the data attribute management table 1000.

In step S1708, the information processing device 100 stores the hash value and data in the data management table 1100 in association with one another.

In step S1710, the information processing device 100 transmits a notification of the success of data addition to the user terminal,

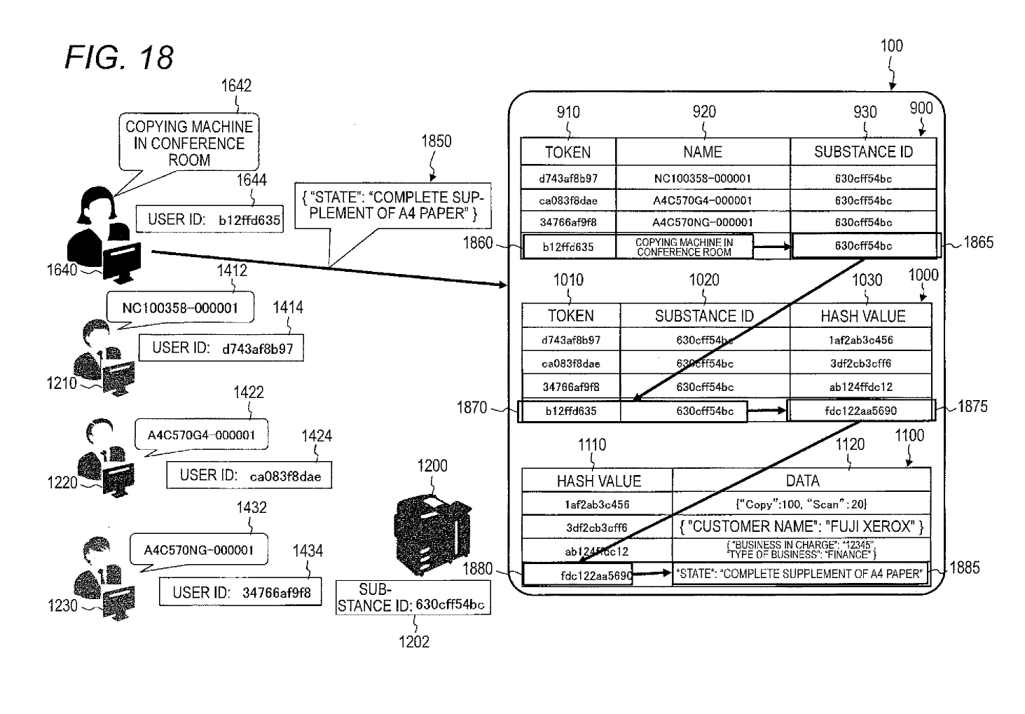

FIG. 18 is an explanatory diagram illustrating an example of a process according to the first embodiment (a detailed example of the process according to the flowchart illustrated in the example of FIG. 17). FIG. 18 illustrates an example in which data is registered through the interface of CRUD. Therefore, it is possible to register data without preparing data bound over the user.

Specifically, the user of the user terminal 1640 registers registration data 1850 (“state: A4 paper is completely supplied”) for the name 1642 (“the copying machine in the conference room”) in the information processing device 100. Although the “instruction” is omitted in the example of FIG. 18, the “instruction” is “Update”.

The information processing device 100 receives the user ID 1644, the name 1642, and the registration data 1850, and extracts a line of target data 1860 from the name management table 900 using the user ID 1644, which is the token, and the name 1642. Meanwhile, the target data 1860 is the combination of data in the token field 910 and data in the name field 920. Further, the information processing device 100 extracts the target data 1865, which corresponds to the target data 1860, in the substance ID field 930. Subsequently, the information processing device 100 extracts a line (target data 1870) of combination of the user ID 1644, which is the token, and the target data 1865 from the data attribute management table 1000. The target data 1870 is the combination of data in the token field 1010 and data in the substance ID field 1020. Further, the information processing device 100 extracts target data 1875, which corresponds to the target data 1870, in the hash value field 1030. Subsequently, the information processing device 100 extracts target data 1880, which corresponds to the target data 1875 in the hash value field 1110, from the data management table 1100. Further, the information processing device 100 specifies target data 1885, which corresponds to the target data 1880, in the data field 1120, and stores the registration data 1850 in the target data 1885.

### Second Embodiment

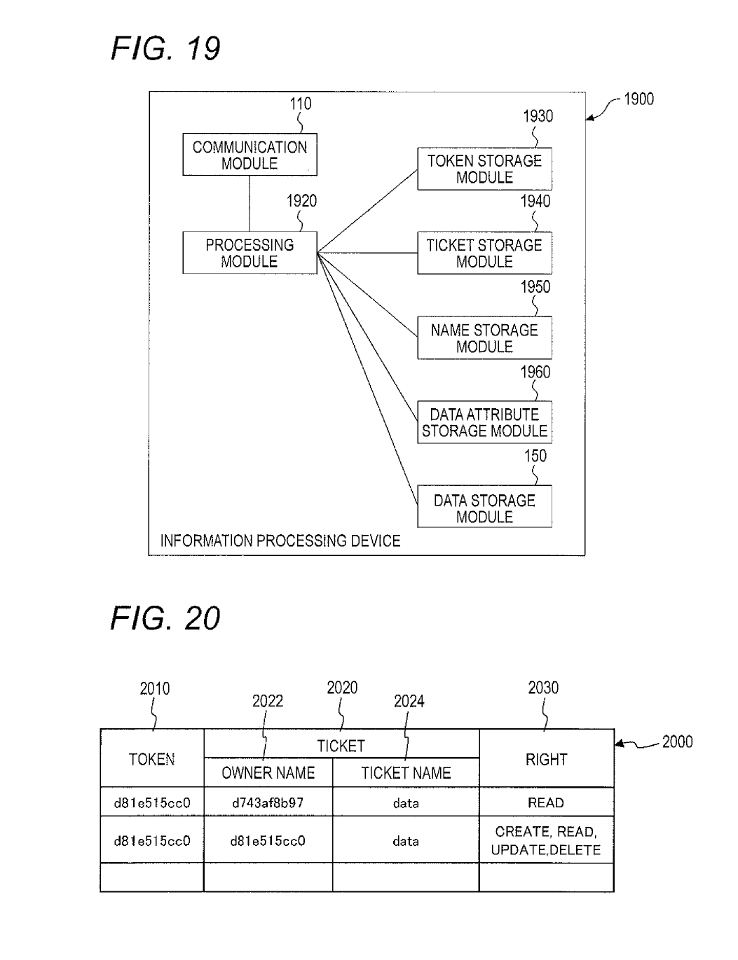

FIG. 19 is a diagram illustrating the configuration of conceptual modules for a configuration example according to a second embodiment.

An information processing device 1900 includes a communication module 110, a processing module 1920, a token storage module 1930, a ticket storage module 1940, a name storage module 1950, a data attribute storage module 1960, and a data storage module 150. Meanwhile, the same reference numerals are attached to similar portions as in the above-described embodiment and the description thereof will not be repeated.

In the second embodiment, in order to realize the reference of data corresponding to the same substance across plural systems, a concept of a ticket which indicates a right is introduced to the first embodiment.

The token (access token) in the first embodiment is treated as a ticket, and the token is a set of plural tickets.

A ticket enables a right to be approved and given to another user.

In addition to the configuration of the first embodiment, the token storage module 1930 and the ticket storage module 1940 are added. Meanwhile, the name storage module 1950 is acquired by extending the name storage module 130 according to the first embodiment, and the data attribute storage module 1960 is acquired by extending the data attribute storage module 140 according to the first embodiment.

The ticket includes an owner name corresponding to a ticket preparing person, an arbitrary ticket name which is named by the owner, and a ticket TD which substitutes for the character string that is formed as the token up to now.

The communication module 110 is connected to the processing module 1920.

The token storage module 1930 is connected to the processing module 1920. The token storage module 1930 stores the “token”, “information (so-called owner) which indicates the owner of the ticket”, the “title of the ticket”, and the “right which is indicated by the ticket” in association with one another. For example, the token storage module 1930 stores a token management table 2000. FIG. 20 is an explanatory diagram illustrating an example of the data structure of the token management table 2000. The token management table 2000 includes a token field 2010, a ticket field 2020, and a right field 2030. The ticket field 2020 includes an owner name field 2022 and a ticket name field 2024. The token field 2010 stores the token. The ticket field 2020 stores a ticket. The owner name field 2022 stores the owner name of the ticket. The ticket name field 2024 stores the ticket name of the ticket. The right field 2030 stores a right which is permitted by the ticket.

Meanwhile, the token storage module 1930 includes entries of plural pieces of ticket information, and it is possible to operate data using the right which is set for each ticket. For example, in a ticket which is approved to a certain user, it is possible to only READ data.

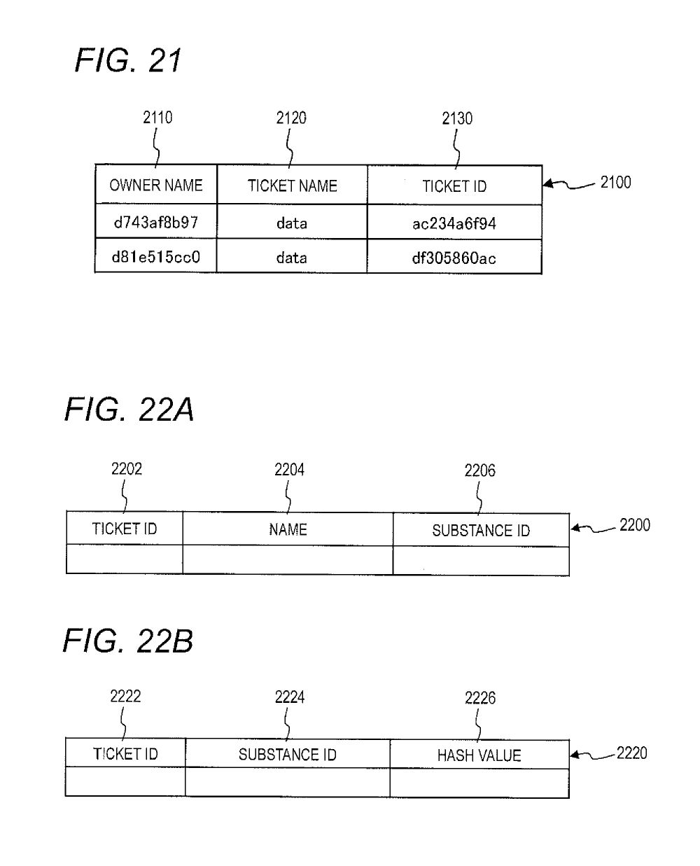

The ticket storage module 1940 is connected to the processing module 1920. The ticket storage module 1940 stores “information indicative of an owner”, a “title of the ticket”, and “information indicative of the ticket” in association with one another. Here, the “information indicative of the ticket” refers to information which specifies the ticket (hereinafter, referred to as a ticket ID). For example, the ticket storage module 1940 stores a ticket management table 2100. FIG. 21 is an explanatory diagram illustrating an example of the data structure of the ticket management table 2100. The ticket management table 2100 includes an owner name field 2110, a ticket name field 2120, and a ticket ID field 2130. The owner name field 2110 stores the owner name of a ticket. The ticket name field 2120 stores the ticket name of the ticket. The ticket ID field 2130 stores information (ticket ID) for uniquely identifying the ticket in the exemplary embodiment.

The name storage module 1950 is connected to the processing module 1920. The name storage module 1950 stores the “information indicative of the ticket”, a “substance name”, and “information indicative of the substance” in association with one another. For example, the name storage module 1950 stores a name management table 2200. FIG. 22A is an explanatory diagram illustrating an example of the data structure of the name management table 2200. The name management table 2200 includes a ticket ID field 2202, a name field 2204, and a substance ID field 2206. The ticket ID field 2202 stores a ticket ID. The name field 2204 stores a name. The substance ID field 2206 stores a substance ID. That is, the token field 910 of the name management table 900, illustrated in the example of FIG. 9, is replaced with the ticket ID field 2202.

The data attribute storage module 1960 is connected to the processing module 1920. The data attribute storage module 1960 stores “information indicative of a ticket”, “information indicative of the substance”, and a “hash value”, in association with one another. For example, the data attribute storage module 1960 stores a data attribute management table 2220. FIG. 22B is an explanatory diagram illustrating an example of the data structure of the data attribute management table 2220.

The data attribute management table 2220 includes a ticket ID field 2222, a substance ID field 2224, and a hash value field 2226. The ticket ID field 2222 stores a ticket ID. The substance ID field 2224 stores a substance ID. The hash value field 2226 stores a hash value. That is, the token field 1010 of the data attribute management table 1000, which is illustrated in the example of FIG. 10, is replaced with the ticket ID field 2222.

The data storage module 150 is connected to the processing module 1920. The data storage module 150 stores the “hash value” and “data” in association with one another.

The processing module 1920 is connected to the communication module 110, the token storage module 1930, the ticket storage module 1940, the name storage module 1950, the data attribute storage module 1960, and the data storage module 150.

In a case in which the processing module 1920 receives the “token indicative of the user”, “information indicative of an owner of the ticket”, the “title of the ticket”, the “name”, and an “instruction to process data relevant to the substance indicated by the name”, the processing module 1920 extracts right, which is indicated by the ticket, from the token storage module 1930.

Further, the processing module 1920 extracts information, which indicates the ticket, corresponding to the “information indicative of an owner of the ticket received by the communication module 110” and the “title of the ticket” from the ticket storage module 1940.

Subsequently, the processing module 1920 extracts information, which indicates the substance, corresponding to the “extracted information indicative of the ticket” and the “name which is received by the communication module 110” from the name storage module 1950.

Further, the processing module 1920 extracts a hash value corresponding to the “extracted information indicative of the ticket” and the “extracted information indicative of the substance” from the data attribute storage module 1960.

Subsequently, the processing module 1920 extracts data corresponding to the “extracted hash value” from the data storage module 150.

Further, the processing module 1920 performs a process on the extracted data according to the instruction, which is received by the communication module 110, in a range of the extracted right.

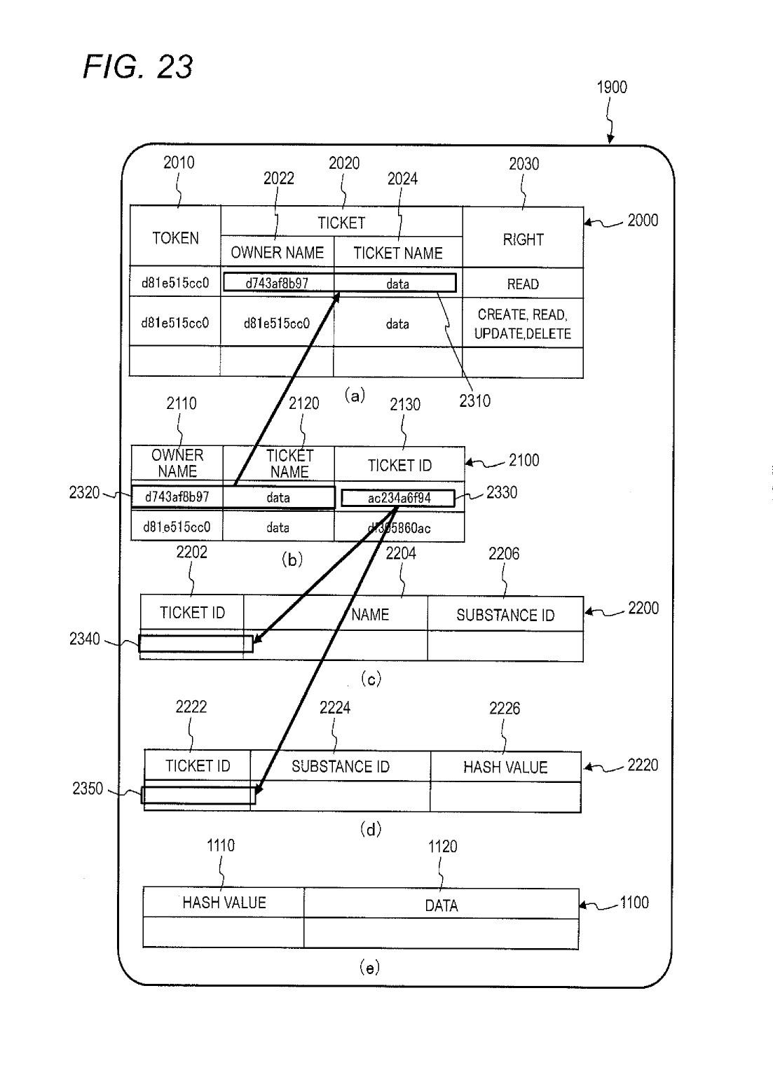

FIG. 23 is an explanatory diagram illustrating an example of a process according to the second embodiment.

The communication module 110 receives a “token”, a “ticket (which includes an owner name of the ticket and a ticket name)”, a “name”, and an “instruction to process data relevant to a substance indicated by the name”.

Further, the processing module 1920 extracts a right (right field 2030, here, “READ”) corresponding to the token and the ticket from the “token” and the “ticket” (target data 2310) which is received by the communication module 110 using the token management table 2000. Meanwhile, the target data 2310 is the combination of the data in the owner name field 2022 and data in the ticket name field 2024,

Subsequently, the processing module 1920 extracts a ticket ID (target data 2330) from the “ticket” (target data 2320) using the ticket management table 2100. Meanwhile, the target data 2320 is the combination of data in the owner name field 2110 and data in the ticket name field 2120.

Thereafter, a process equivalent to the process according to the first embodiment is performed using the name management table 2200, the data attribute management table 2220, and the data management table 1100 while the token in the first embodiment is used as the ticket ID (target data 2340, target data 2350), with the result that data of the data field 1120 of the data management table 1100 is acquired, and thus a process is performed on the data according to the “instruction”. However, here, the process is performed in a range of the right “READ”.

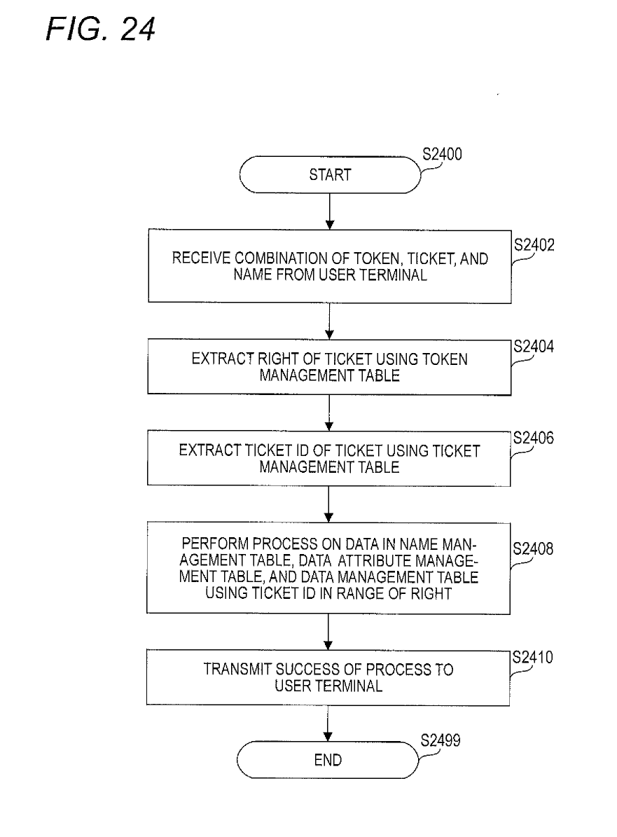

FIG. 24 is a flowchart illustrating an example of a process according to the second embodiment.

In step S2402, the combination of the token, the ticket, and the name is received from the user terminal.

In step S2404, the right of the ticket is extracted using the token management table 2000.

In step S2406, the ticket ID of the ticket is extracted using the ticket management table 2100.

In step S2408, the process is performed on the data in the name management table 2200, the data attribute management table 2220, and the data management table 1100 using the ticket ID in the range of the right.

In step S2410, a notification of the success of the process is transmitted to the user terminal.

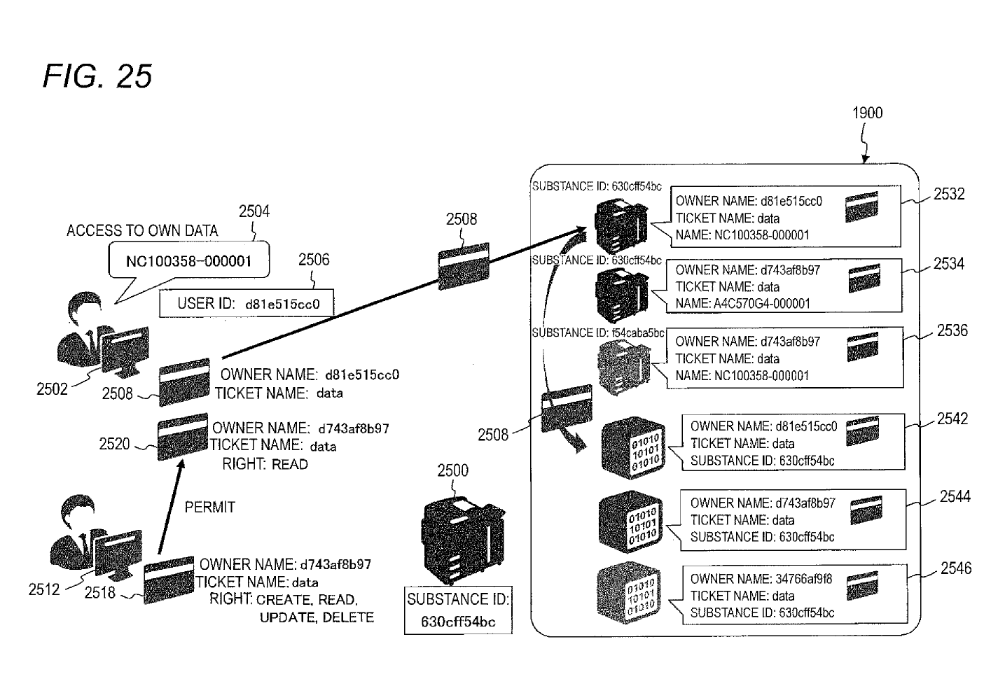

FIG. 25 is an explanatory diagram illustrating an example of a process according to the second embodiment (a detailed example of the process of the flowchart illustrated in the example of FIG. 24), that is, an example of a process of accessing own data using a ticket. A process equivalent to the process according to the first embodiment is also possible in the second embodiment.

A ticket 2508 include “an owner name: d81e515cc0 and a ticket name: data”, a ticket 2518 includes “an owner name: d743af8b97, a ticket name: data, and rights: CREATE, READ, UPDATE, and DELETE”, and a ticket 2520 includes “an owner name: d743af8b97, a ticket name: data, and a right: READ”. Meanwhile, although not illustrated in the example of FIG. 25, the ticket 2508 is the own data, and thus the ticket 2508 includes the “rights: CREATE, READ, UPDATE, and DELETE”.

A user of the user terminal 2502 has the ticket 2508. A user of the user terminal 2512 has the ticket 2518. Meanwhile, the user of the user terminal 2502 receives the ticket 2520 from the user of the user terminal 2512. However, the ticket 2520 is not used in the example of FIG. 25.

The information processing device 1900 receives a name 2504, a user ID 2506, and the ticket 2508 from the user terminal 2502. Meanwhile, although the “instruction” is omitted in the example of FIG. 25, the “instruction” may be, for example, “Read” or the like.

Substance data 2532 includes “an owner name: d81e515cc0, a ticket name: data, and a name: NC100358-000001”, substance data 2534 includes “an owner name: d743af8b97, a ticket name: data, and a name: A4C570G4-000001”, and substance data 2536 includes “an owner name: d743af8b97, a ticket name: data, and a name: NC100358-000001”.

Data 2542 includes “an owner name: d81e515cc0, a ticket name: data, and a substance: 630cff54bc”, a data 2544 includes “an owner name: d743af8b97, a ticket name: data, and a substance: 630cff54bc”, and data 2546 includes “an owner name: 34766af9f8, a ticket name: data, and a substance: 630eff54bc”.

As described above, the right is extracted from the ticket 2508 using the token management table 2000, the ticket ID is extracted from the ticket 2508 using the ticket management table 2100, the substance (substance data 2532) is acquired from the ticket ID using the name management table 2200 and the data attribute management table 2220, and the data (data 2542) in the data field 1120 of the data management table 1100 is acquired. Further, the process is performed according to the “instruction” in the range of the rights (in the example, the range of “the rights: CREATE, READ, UPDATE, and DELETE”, so-called the range of the whole rights).

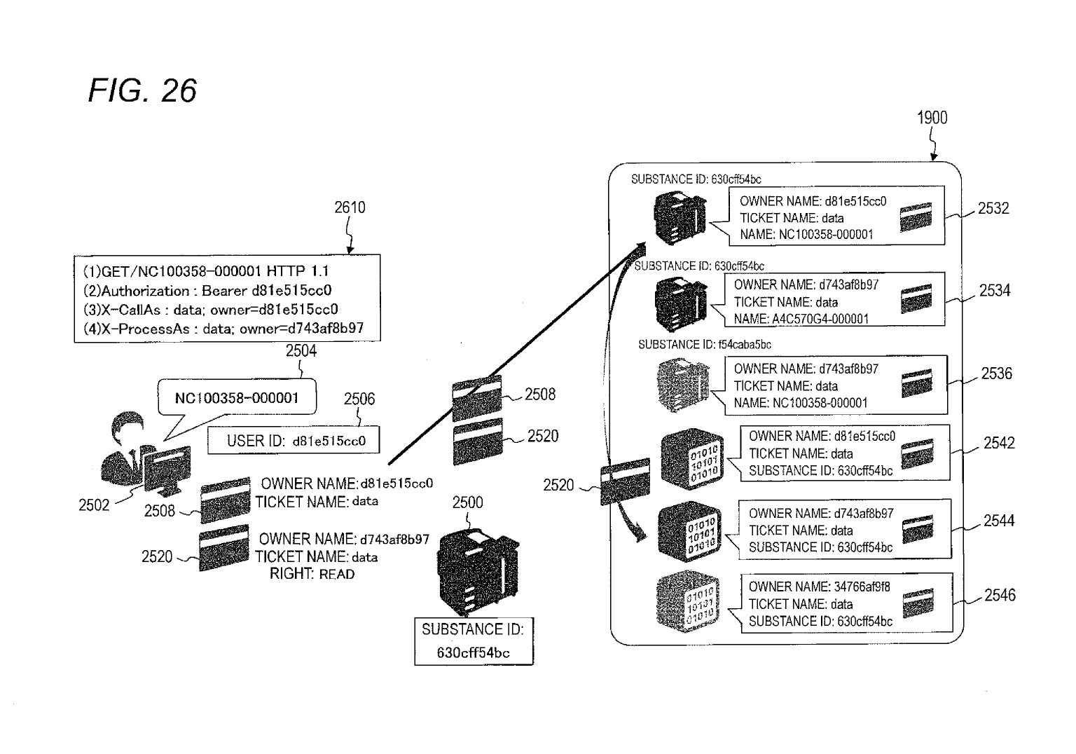

FIG. 26 is an explanatory diagram illustrating an example of a process according to the second embodiment (a detailed example of the process of the flowchart illustrated in the example of FIG. 24), that is, an example of a process of sharing data using a ticket.

In a case in which each data is operated, tickets may be switched between a process of resolving (extracting) a substance from a name and a process of resolving data from the substance.

Specifically, expansion headers for designating tickets, which are used in the respective processes, are provided to HTTP headers, and tickets to be used are switched.

In the example of FIG. 26, data of another user is accessed.

A substance is specified using an own name which is being used in the step of resolving the substance from the name and the ticket 2520 which is approved by another user is used in the step of resolving the data from the substance, and thus it is possible to acquire the data of another user even though a name which is used by another user is not known.

For example, access description 2610 is written as the HTTP headers. As a detailed example, the followings are described.

(1) GET/NC100358-000001 HTTP 1.1

(2) Authorization: Bearer d81e515cc0

(3) X-CallAs: data; owner=d81e515cc0

(4) X-ProcessAs: data; owner=d743af8b97

The third line of the access description 2610 means the “resolution of the name”, and the fourth line of the access description 2610 means the “resolution of the data”.

The information processing device 1900 receives the name 2504, the user ID 2506, the ticket 2508, the ticket 2520, and the instruction. Meanwhile, although the “instruction” is omitted in the example of FIG. 26, the “instruction” may be, for example, “Read” or the like. The substance data 2532 of the substance 2500 (the substance is resolved from the name) is acquired using the ticket 2508, and the data 2544 of another user is acquired using the ticket 2520 (a process of resolving the data from the substance). Further, a process is performed on the data 2544. Here, the process is performed in the range of the right (READ) of the ticket 2520.

Furthermore, the information processing device 1900 may handle imperilment.

If the token (access token) is directly used as the owner name, it is difficult to destroy the token in a case in which the token is leaked to another person, and thus the token storage module 1930 may has a configuration as a token management table 2700 and a user ticket management table 2800. Therefore, it is possible to link (associate) the token to the user ID in a system authorization operation. Accordingly, it is possible to enable the token to be destroyed.

In addition, therefore, it is possible to prepare a HTTP request using a human readable character string besides the token, and thus development becomes easy.

The token storage module 1930 stores the token management table 2700 and the user ticket management table 2800.

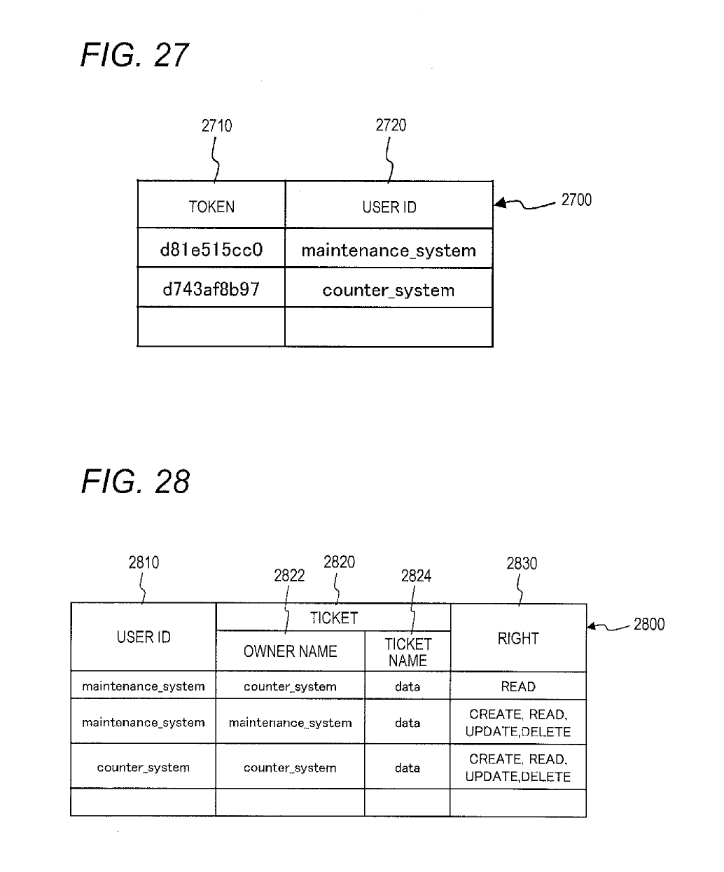

FIG. 27 is an explanatory diagram illustrating an example of the data structure of the token management table 2700. The token management table 2700 includes a token field 2710 and a user ID field 2720. That is, the token management table 2700 stores a token and information indicative of a user in association with one another. The token field 2710 stores a token. The user ID field 2720 stores information (user ID) for uniquely identifying the user in the exemplary embodiment.

FIG. 28 is an explanatory diagram illustrating an example of the data structure of the user ticket management table 2800. The user ticket management table 2800 includes a user ID field 2810, a ticket field 2820, and a right field 2830. The ticket field 2820 includes an owner name field 2822 and a ticket name field 2824. That is, the user ticket management table 2800 stores information indicative of a user, information indicative of an owner of a ticket (owner), a title of the ticket, and a right which is indicated by the ticket in association with one another. The user ID field 2810 stores a user ID. The ticket field 2820 stores a ticket. The owner name field 2822 stores an owner name. The ticket name field 2824 stores a ticket name. The right field 2830 stores a right.

The ticket storage module 1940 stores the token management table 2700, in which a token and information indicative of a user are stored in association with one another, and the user ticket management table 2800.

In a case in which the communication module 110 receives a token”, “information indicative of an owner of a ticket”, the “title of the ticket”, a “name”, and an “instruction to process data relevant to a substance indicated by the name”, the processing module 1920 extracts information indicative of a user who is associated with the from the token management table 2700.

Further, the processing module 1920 extracts the extracted information indicative of the user, the information indicative of an owner of the ticket and is received by the communication module 110, and a right corresponding to the title of the ticket from the user ticket management table 2800.

Subsequently, the processing module 1920 extracts the information, which indicates an owner of the ticket and is received by the communication module 110, and the information, which indicates the ticket corresponding to the title of the ticket, from the ticket storage module 1940.

Further, the processing module 1920 extracts the extracted information, which indicates the ticket, and the information, which indicates the substance corresponding to the name received by the communication module 110, from the name storage module 1950.

Subsequently, the processing module 1920 extracts a hash value corresponding to the extracted information indicative of the ticket and the extracted information indicative of the substance from the data attribute storage module 1960.

Further, the processing module 1920 extracts data corresponding to the extracted hash value from the data storage module 150.

Subsequently, the processing module 1920 performs a process on the extracted data according to the instruction, which is received by the communication module 110, in the range of the extracted right.

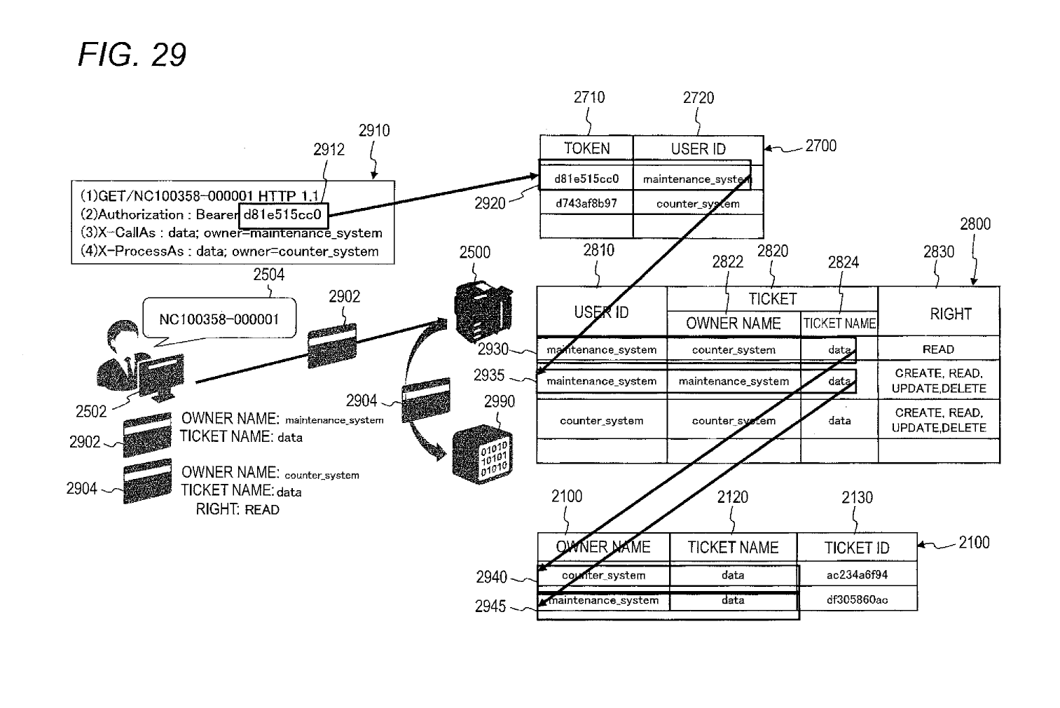

FIG. 29 is an explanatory diagram illustrating an example of a process (example of a process using the token management table 2700 and the user ticket management table 2800) according to the second embodiment.

In the example of FIG. 29, data of another user is accessed.

As the HTTP header, for example, an access description 2910 is described. As a detailed example, the followings are described.

(1) GET/NC100358-000001 HTTP 1.1

(2) Authorization: Bearer d81e515cc0

(3) X-CallAs: data; owner=maintenance_system

(4) X-ProcessAs; data; owner=counter_system

The third line of the access description 2910 means the “resolution of a name”, and the fourth line of the access description 2910 means the “resolution of data”.

The information processing device 1900 receives a name 2504, target data 2912, a ticket 2902, a ticket 2904, and an instruction. Meanwhile, although the “instruction” is omitted in the example of FIG. 29, the instruction may be, for example, “Read” or the like.

The ticket 2902 includes an “owner name: maintenance_{—} system and a ticket name: data”, and the ticket 2904 includes an “owner name: counter_system, a ticket name: data, and a right: READ”.

The target data 2912 is “d81e515cc0”. The target data 2920 (specially, the user ID of the user ID field 2720) is extracted from the target data 2912 using the token management table 2700. The target data 2920 is the combination of data in the token field 2710 and data in the user ID field 2720.

Further, target data 2930 and target data 2935 are extracted from the user ID of the target data 2920, the ticket 2902, and the ticket 2904 using the user ticket management table 2800. The target data 2930 is the combination of data in the user ID field 2810, data in the owner name field 2822, and data in the ticket name field 2824. The target data 2935 is the combination of the data in the user ID field 2810 the data in the owner name field 2822, and the data in the ticket name field 2824.

Subsequently, target data 2940 is extracted from the owner name and the ticket name in the target data 2930 using the ticket management table 2100. Further, target data 2945 is extracted from the owner name and the ticket name in the target data 2935 using the ticket management table 2100. The target data 2940 is the combination of data in the owner name field 2110 and data in the ticket name field 2120. The target data 2945 is the combination of data in the owner name field 2110 and data in the ticket name field 2120.

Thereafter, as described above, data relevant to the substance is acquired using the name management table 2200, the data attribute management table 2220, and the data management table 1100, a process is performed on the data group according to the instruction received by the communication module 110 in the range of the extracted right (CREATE, READ, UPDATE, and DELETE in the ticket 2902, and READ in the ticket 2904).

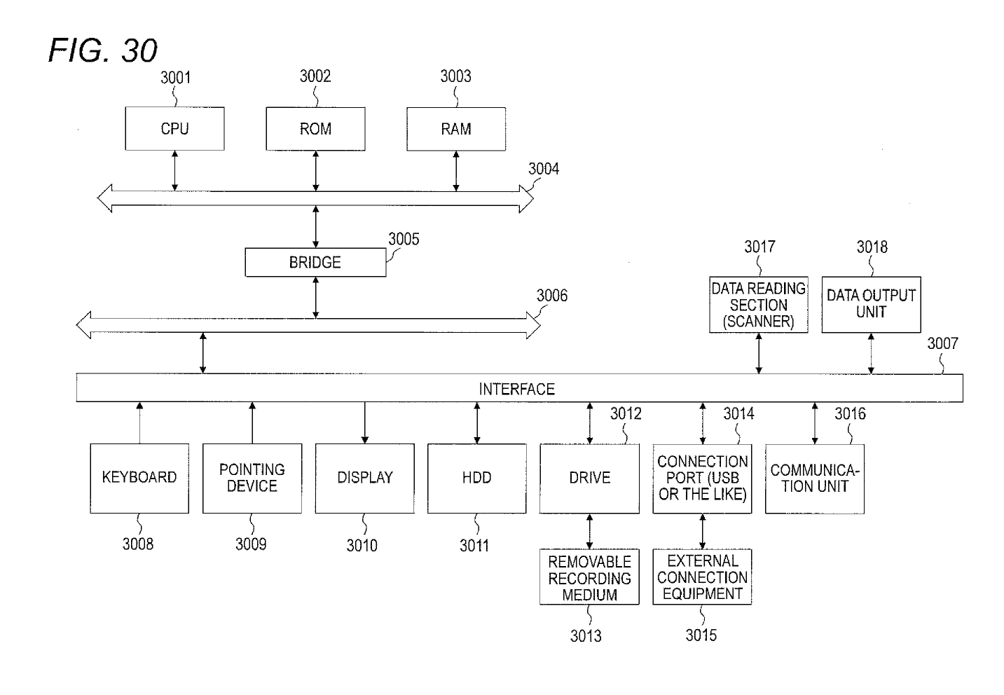

An example of the hardware configuration of the information processing device according to the exemplary embodiment will be described with reference to FIG. 30. The configuration illustrated in FIG. 30 is formed by, for example, a personal computer (PC) or the like, and illustrates an example of the hardware configuration which includes a data reading unit 3017, such as a scanner, and a data output unit 3018 such as a printer.

A Central Processing Unit (CPU) 3001 is a control unit which executes a process according to a computer or a program that describes the execution sequence of each of the various modules which are described in the above-described embodiment, that is, the communication module 110, the processing module 120, the processing module 1920, and the like.

A Read Only Memory (ROM) 3002 stores programs, arithmetic parameters, and the like which are used by the CPU 3001. A Random Access Memory (RAM) 3003 stores programs, which are used when the CPU 3001 is executed, and parameters which are appropriately changed in the execution of the CPU 3001, and the like. The CPU 3001, the ROM 3002, and the RAM 3003 are connected to each other through a host bus 3004 which includes a CPU bus and the like.

The host bus 3004 is connected to an external bus 3006, such as a PERIPHERAL COMPONENT INTERCONNECT/INTERFACE (PCI) bus or the like through a bridge 3005.

A keyboard 3008 and a pointing device 3009, such as a mouse, are devices which are operated by an operator. The display 3010 includes a liquid crystal device, a CATHODE RAY TUBE (CRT), and the like, and displays various pieces of information as text and image information. In addition, the display 3010 may include a touch screen or the like which has the functions of both the pointing device 3009 and the display 3010.

A HARD DISK DRIVE (HDD) 3011 includes a built-in hard disk (which may be a flash memory or the like), drives the hard disk, and records and reproduces a program and information which are executed by the CPU 3001. The hard disk realizes the functions of the name storage module 130, the data attribute storage module 140, the data storage module 150, the token storage module 1930, the ticket storage module 1940, the name storage module 1950, the data attribute storage module 1960, and the like. Furthermore, other various data, various computer programs, and the like are stored in the HDD 3011.

A drive 3012 reads data or a program which is recorded in a mounted removable recording medium 3013, such as a magnetic disk, an optical disk, a magneto-optical disk, or a semiconductor memory, and supplies the data or the program to the RAM 3003 which is connected through an interface 3007, the external bus 3006, the bridge 3005, and the host bus 3004. Meanwhile, it is possible to use the removable recording medium 3013 as a data recording area.

A connection port is a port which connects to external connection equipment 3015, and includes a connection unit such as a USB, IEEE1394, or the like. The connection port 3014 is connected to the CPU 3001 or the like through the interface 3007, the external bus 3006, the bridge 3005, the host bus 3004, and the like. The communication unit 3016 is connected to the communication line, and performs a data communication process with the outside. The data reading unit 3017 is, for example, a scanner, and performs a document reading process. The data output unit 3018 is, for example, a printer, and performs a document data outputting process.

Meanwhile, the hardware configuration of the information processing device illustrated in FIG. 30 illustrates one example of the configuration. The exemplary embodiment is not limited to the configuration illustrated in FIG. 30, and may include a configuration in which it is possible to execute the modules described in the exemplary embodiment. For example, some modules may be formed by dedicated hardware (for example, Application Specific Integrated Circuit (ASIC) or the like), some modules may be included in an external system and connected by a communication line, and, further, plural systems illustrated in FIG. 30 may be connected with each other by the communication line so as to perform cooperative operation with each other. In addition, specifically, the modules may be embedded into a portable information communication device, a home information appliance, robot, a copying machine, a facsimile, a scanner, a printer, a multifunction machine, or the like in addition to the personal computer.

Meanwhile, the above-described program may be provided after being stored in the recording medium or the program may be provided by a communication section. In this case, for example, the above-described program may be understood as the invention of a “computer readable recording medium storing a program”.

The “computer readable recording medium storing a program” indicates a computer readable recording medium in which a program is recorded, the computer readable recording medium being used for installation, execution, and distribution of the program.

Meanwhile, the recording medium includes, for example, a “DVD-R, a DVD-RW, a DVDRAM, and the like”, which are Digital Versatile Disks (DVD) and are standards formulated at a DVD forum, a “DVD+R, a DVD+RW, and the like” which are standards formulated at the DVD+RW, a read-only memory (CD-ROM), a CD recordable (CD-R), a CD rewritable (CD-RW), and the like which are Compact Disks (CD), a Blu-ray (registered trade mark) Disc, a Magneto-Optical (MO) disk, a Flexible Disk (FD), a magnetic tape, a hard disk, a Read-Only Memory (ROM), an ELECTRICALLY ERASABLE PROGRAMMABLE READ-ONLY MEMORY (EEPROM (registered trade mark)), a flash memory, a Random Access Memory (RAM), a Secure Digital (SD) memory card, and the like.

Further, the whole or a part of the program may be preserved or distributed after being recorded in the recording medium. In addition, the program may be transmitted through a transmission medium, such as a wired network, a wireless communication network, or the combination thereof, which is used for, for example, a Local Area Network (LAN), a Metropolitan Area Network (MAN), a Wide Area Network (WAN), the Internet, the Intranet, the Extranet, or the like depending on communications. In addition, the program may be transported by being placed on carrier waves.

Furthermore, the program may be a part or the whole of another program, or may be recorded in a recording medium together with an individual program. In addition, the program may be divided and recorded in plural recording media. In addition, if it is possible to restore the program through compression, encryption, or the like, the program may be recorded in any type of manner.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing device comprising:
a first storage section that stores a token, a name of a substance, and information indicative of the substance in association with one another;
a second storage section that stores the token, the information indicative of the substance, and a hash value in association with one another;
a third storage section that stores the hash value and data in association with one another;
a first extraction section that, in a case in which a token indicative of a user, a name, and an instruction to process data relevant to a substance indicated by the name are received, extracts the information indicative of the substance corresponding to the received token and the received name from the first storage section;
a second extraction section that extracts, from the second storage section, the hash value corresponding to the received token and the information indicative of the substance extracted by the first extraction section;
a third extraction section that extracts, from the third storage section, the data corresponding to the hash value extracted by the second extraction section; and
a processing section that performs, according to the instruction, a process on the data extracted by the third extraction section.

2. An information processing device comprising:
a first storage section that stores a token, information indicative of an owner of a ticket, a title of the ticket, and a right indicated by the ticket in association with one another;
a second storage section that stores the information indicative of the owner, the title of the ticket, and information indicative of the ticket in association with one another;
a third storage section that stores the information indicative of the ticket, a name of a substance, and information indicative of the substance in association with one another;
a fourth storage section that stores the information indicative of the ticket, the information indicative of the substance, and a hash value in association with one another;
a fifth storage section that stores the hash value and data in association with one another;
a first extraction section that, in a case in which a token indicative of the user, information indicative of an owner of a ticket, a title of the ticket, a name, and an instruction to process data relevant to a substance indicated by the name are received, extracts the right which is indicated by the ticket from the first storage section;
a second extraction section that extracts, from the second storage section, the information indicative of the ticket corresponding to the received information indicative of the owner of the ticket and the received title of the ticket;
a third extraction section that extracts, from the third storage section, the information indicative of the substance corresponding to the information indicative of the ticket extracted by the second extraction section and the received name;
a fourth extraction section that extracts, from the fourth storage section, the hash value corresponding to the information indicative of the ticket extracted by the second extraction section and the information indicative of the substance extracted by the third extraction section;
a fifth extraction section that extracts, from the fifth storage section, data corresponding to the hash value extracted by the fourth extraction section; and
a processing section that performs, according to the instruction, a process on the data extracted by the fifth extraction section in a range of the right extracted by the first extraction section.

3. An information processing device comprising:
a first storage section that stores a token and information indicative of a user in association with one another;
a second storage section that stores the information indicative of the user, information indicative of an owner of a ticket, a title of the ticket, and a right which is indicated by the ticket in association with one another;
a third storage section that stores the information indicative of the owner of the ticket, the title of the ticket, and information indicative of the ticket in association with one another;
a fourth storage section that stores the information indicative of the ticket, a name of a substance, and information indicative of the substance in association with one another;
a fifth storage section that stores the information indicative of the ticket, the information indicative of the substance, and a hash value in association with one another;
a sixth storage section that stores the hash value and data in association with one another;
a first extraction section that, in a case in which a token, information indicative of an owner of a ticket, a title of a ticket, a name, and an instruction to process the data relevant to a substance indicated by the name are received, extracts the information indicative of the user from the first storage section;
a second extraction section that extracts, from the second storage section, the right corresponding to the information indicative of the user extracted by the first extraction section, the received information indicative of the owner of the ticket, and the received title of the ticket;
a third extraction section that extracts, from the third storage section, the information indicative of the ticket corresponding to the received information indicative of the owner of the ticket and the received title of the ticket;
a fourth extraction section that extracts, from the fourth storage section, the information indicative of the substance corresponding to the information indicative of the ticket extracted by the third extraction section and the received name;
a fifth extraction section that extracts, from the fifth storage section, the hash value corresponding to the information indicative of the ticket extracted by the third extraction section and the information indicative of the substance extracted by the fourth extraction section;
a sixth extraction section that extracts, from the sixth storage section, data corresponding to the hash value extracted by the fifth extraction section; and
a processing section that performs, according to the instruction, a process on the data extracted by the sixth extraction section in a range of the right extracted by the second extraction section.

4. An information processing method comprising:
providing a first storage section that stores a token, a name of a substance, and information indicative of the substance in association with one another;
providing a second storage section that stores the token, the information indicative of the substance, and a hash value in association with one another;
providing a third storage section that stores the hash value and data in association with one another;
receiving a token indicative of a user, a name, and an instruction to process data relevant to a substance indicated by the name;
extracting the information indicative of the substance corresponding to the received token and the received name from the first storage section;
extracting, from the second storage section, the hash value corresponding to the received token and the extracted information indicative of the substance;
extracting, from the third storage section, the data corresponding to the extracted hash value; and
performing, according to the instruction, a process on the extracted data.

5. An information processing method comprising:
providing a first storage section that stores a token, information indicative of an owner of a ticket, a title of the ticket, and a right indicated by the ticket in association with one another;
providing a second storage section that stores the information indicative of the owner, the title of the ticket, and information indicative of the ticket in association with one another;
providing a third storage section that stores the information indicative of the ticket, a name of a substance, and information indicative of the substance in association with one another;
providing a fourth storage section that stores the information indicative of the ticket, the information indicative of the substance, and a hash value in association with one another;
providing a fifth storage section that stores the hash value and data in association with one another;
receiving a token indicative of the user, information indicative of an owner of a ticket, a title of the ticket, a name, and an instruction to process data relevant to a substance indicated by the name;
extracting the right which is indicated by the ticket from the first storage section;
extracting, from the second storage section, the information indicative of the ticket corresponding to the received information indicative of the owner of the ticket and the received title of the ticket;
extracting, from the third storage section, the information indicative of the substance corresponding to the extracted information indicative of the ticket and the received name;
extracting, from the fourth storage section, the hash value corresponding to the extracted information indicative of the ticket and the extracted information indicative of the substance;
extracting, from the fifth storage section, data corresponding to the extracted hash value; and
performing, according to the instruction, a process on the extracted data in a range of the extracted right.

6. An information processing method comprising:
providing a first storage section that stores a token and information indicative of a user in association with one another;
providing a second storage section that stores the information indicative of the user, information indicative of an owner of a ticket, a title of the ticket, and a right which is indicated by the ticket in association with one another;
providing a third storage section that stores the information indicative of the owner of the ticket, the title of the ticket, and information indicative of the ticket in association with one another;
providing a fourth storage section that stores the information indicative of the ticket, a name of a substance, and information indicative of the substance in association with one another;
providing a fifth storage section that stores the information indicative of the ticket, the information indicative of the substance, and a hash value in association with one another;
providing a sixth storage section that stores the hash value and data in association with one another;
receiving a token, information indicative of an owner of a ticket, a title of a ticket, a name, and an instruction to process the data relevant to a substance indicated by the name;
extracting the information indicative of the user from the first storage section;
extracting, from the second storage section, the right corresponding to the extracted information indicative of the user, the received information indicative of the owner of the ticket, and the received title of the ticket;
extracting, from the third storage section, the information indicative of the ticket corresponding to the received information indicative of the owner of the ticket and the received title of the ticket;
extracting, from the fourth storage section, the information indicative of the substance corresponding to the extracted information indicative of the ticket and the received name;
extracting, from the fifth storage section, the hash value corresponding to the extracted information indicative of the ticket and the extracted information indicative of the substance;
extracting, from the sixth storage section, data corresponding to the extracted hash value; and
performs, according to the instruction, a process on the extracted data in a range of the right extracted by the second extraction section.

7. A non-transitory computer readable medium storing an information processing program causing a computer to execute as:
a first storage section that stores a token, a name of a substance, and information indicative of the substance in association with one another;
a second storage section that stores the token, the information indicative of the substance, and a hash value in association with one another;
a third storage section that stores the hash value and data in association with one another;
a first extraction section that, in a case in which a token indicative of a user, a name, and an instruction to process data relevant to a substance indicated by the name are received, extracts the information indicative of the substance corresponding to the received token and the received name from the first storage section;
a second extraction section that extracts, from the second storage section, the hash value corresponding to the received token and the information indicative of the substance extracted by the first extraction section;
a third extraction section that extracts, from the third storage section, the data corresponding to the hash value extracted by the second extraction section; and
a processing section that performs, according to the instruction, a process on the data extracted by the third extraction section.

8. A non-transitory computer readable medium storing an information processing program causing a computer to execute as:
a first storage section that stores a token, information indicative of an owner of a ticket, a title of the ticket, and a right indicated by the ticket in association with one another;
a second storage section that stores the information indicative of the owner, the title of the ticket, and information indicative of the ticket in association with one another;
a third storage section that stores the information indicative of the ticket, a name of a substance, and information indicative of the substance in association with one another;
a fourth storage section that stores the information indicative of the ticket, the information indicative of the substance, and a hash value in association with one another;
a fifth storage section that stores the hash value and data in association with one another;
a first extraction section that, in a case in which a token indicative of the user, information indicative of an owner of a ticket, a title of the ticket, a name, and an instruction to process data relevant to a substance indicated by the name are received, extracts the right which is indicated by the ticket from the first storage section;
a second extraction section that extracts, from the second storage section, the information indicative of the ticket corresponding to the received information indicative of the owner of the ticket and the received title of the ticket;
a third extraction section that extracts, from the third storage section, the information indicative of the substance corresponding to the information indicative of the ticket extracted by the second extraction section and the received name;
a fourth extraction section that extracts, from the fourth storage section, the hash value corresponding to the information indicative of the ticket extracted by the second extraction section and the information indicative of the substance extracted by the third extraction section;
a fifth extraction section that extracts, from the fifth storage section, data corresponding to the hash value extracted by the fourth extraction section; and
a processing section that performs, according to the instruction, a process on the data extracted by the fifth extraction section in a range of the right extracted by the first extraction section.

9. A non-transitory computer readable medium storing an information processing program causing a computer to execute as:
a first storage section that stores a token and information indicative of a user in association with one another;
a second storage section that stores the information indicative of the user, information indicative of an owner of a ticket, a title of the ticket, and a right which is indicated by the ticket in association with one another;
a third storage section that stores the information indicative of the owner of the ticket, the title of the ticket, and information indicative of the ticket in association with one another;
a fourth storage section that stores the information indicative of the ticket, a name of a substance, and information indicative of the substance in association with one another;
a fifth storage section that stores the information indicative of the ticket, the information indicative of the substance, and a hash value in association with one another;
a sixth storage section that stores the hash value and data in association with one another;
a first extraction section that, in a case in which a token, information indicative of an owner of a ticket, a title of a ticket, a name, and an instruction to process the data relevant to a substance indicated by the name are received, extracts the information indicative of the user from the first storage section;
a second extraction section that extracts, from the second storage section, the right corresponding to the information indicative of the user extracted by the first extraction section, the received information indicative of the owner of the ticket, and the received title of the ticket;
a third extraction section that extracts, from the third storage section, the information indicative of the ticket corresponding to the received information indicative of the owner of the ticket and the received title of the ticket;
a fourth extraction section that extracts, from the fourth storage section, the information indicative of the substance corresponding to the information indicative of the ticket extracted by the third extraction section and the received name;
a fifth extraction section that extracts, from the fifth storage section, the hash value corresponding to the information indicative of the ticket extracted by the third extraction section and the information indicative of the substance extracted by the fourth extraction section;
a sixth extraction section that extracts, from the sixth storage section, data corresponding to the hash value extracted by the fifth extraction section; and
a processing section that performs, according to the instruction, a process on the data extracted by the sixth extraction section in a range of the right extracted by the second extraction section.
